(19) United States
(12) Patent Application Publication
(10) Pub. No.: US 2015/0302797 A1
(43) Pub. Date: Oct. 22, 2015

(54) LED DISPLAY DEVICE AND LED CONTROL SYSTEM

(71) Applicants: Changjun LU, Beijing (CN); Zhiyong LIU, Beijing (CN)

(72) Inventors: Changjun LU, Bejing (CN); Zhiyong LIU, Beijing (CN)

(21) Appl. No.: 14/648,679

(22) PCT Filed: May 22, 2013
(86) PCT No.: PCT/CN2013/076052

§ 371 Date: May 29, 2015

(30) Foreign Application Priority Data
Nov. 29, 2012 (CN) 201210501956.0

(51) Int. Cl. G09G 3/32

(52) U.S. Cl. CPC G09G 3/3225; G09G 2310/08; G09G 2320/0252; G09G 2300/0452; G09G 2300/0426

(57) ABSTRACT

An LED display device and an LED control system. The display device comprises: an LED display panel (10); a display driver circuit (30) that comprises: a switch circuit (31), a driver circuit (33), and a control circuit (35), where a first terminal of one between the switch circuit (31) and the driver circuit (33) is connected to a power supply terminal of a power supply device, while a first terminal of the other is connected to a ground terminal of the power supply device, and a second terminal of the one between the switch circuit (31) and the driver circuit (33) is connected to an anode of the LED display panel (10), while a second terminal 353 of the other is connected to a cathode of the LED display panel (10); and, a control circuit (35) that comprises: a power supply control circuit (351) and a driver control circuit (353), where the power supply control circuit (351) is connected to a third terminal of the switch circuit (31) via a power supply control port, and the driver control circuit (353) controls the turning on or turning off of the driver circuit (33). The display device integrates the switch circuit (31), the driver circuit (33), and the control circuit (35) into the display driver circuit (30).

### TECHNICAL FIELD

The disclosure relates to the field of Light-Emitting Diode (LED) control, in particular, to an LED display and an LED control system.

### BACKGROUND

At present, a discrete placement mode is adopted for LEDs, P-channel Metal Oxide Semiconductor (P-MOS) transistors and an LED driving circuit during the design of a unit board of an LED display. As shown in FIG. 1b: LED particles in FIG. 1b are four-pin red/green/blue (R/G/B) common-anode three-in-one LEDs, pins 1 are common anodes, and pins 2/3/4 are cathodes of the B/G/R three primary colors LEDs respectively; and one of control ports of an external display control logic circuit is a constant current control signal output port, the other of the control ports is a line power supply control port, and the constant current control signal output port is matched with the line power supply control port to realize the display work of an LED array.

FIG. 1a to FIG. 1c are discrete placement diagrams of an LED driving circuit for common-anode three-in-one LED particles in the related art. As shown in FIG. 1a, the LED driving circuit includes three logic circuits and corresponding constant current channel groups, i.e. LED driving control circuits for controlling R/G/B in the LED unit board display respectively, and the three integrated circuits have the same internal architecture, and drive the display of the LED array under the control of the external display control logic circuit. A current LED driving circuit includes multiple independent constant current logic components forming a constant current array; each constant current logic component consists of a constant current input end, a constant current output end and a constant current control end, the constant current output ends of the constant current array are connected with an external pin GND of the LED driving circuit; the constant current array is controlled by a internal logic circuit of the LED driving control circuits in a unified way to realize the ordered work of each independent constant current logic component and control the display of external LEDs; the internal logic circuit also includes two parts, i.e. an LED driving circuit input signal port and an output signal port, wherein the input signal port is connected to the constant current control signal output port of an external display driving circuit 30′, and the output signal port is used for cascading the input signal port of the LED driving circuit of the next stage or is idled; and P-MOS components shown in FIG. 1c are controlled by the line power supply control port to realize line-by-line power supply control of the LED array.

The LED unit board consists of an LED matrix with M lines and N columns, anodes of the LEDs in a single line are interconnected to drains of the P-MOS transistors, and common cathodes of primary color of the LEDs in a single column are interconnected to a constant current input end of the LED driving circuit; sources of the P-MOS transistors are connected to a power supply end VCC, and gates of the P-MOS transistors are connected to the line power supply control port; and under the control of the display driving circuit 30′, the drain of a certain P-MOS transistor is switched on to supply power to the anodes of the LEDs in the corresponding line, the constant current control signal output port controls the logic circuits of the LED driving circuit to control the ordered turning-on of the constant current array and realize the ordered turning-on of the current of the LEDs in the line to GND to realize the ordered switching-on of the LEDs.

From the above, the P-MOS transistors, the LED driving circuit and the display driving circuit 30′ are independently encapsulated electronic components, and a Printed Circuit Board (PCB) area occupied by the P-MOS transistors, the LED driving circuit and the display driving circuit 30′ for the display of the LED array of a certain resolution under the conditions of a certain scanning mode and a certain P-MOS transistor load is a fixed value, that is, the PCB area occupied by the components is a fixed value, which inevitably brings the problems of low refreshing rate and high design difficulty during application to a control mode of a high-density LED display.

In addition, FIG. 2a to FIG. 2c are discrete placement circuit diagrams of an LED driving circuit for 6-pin R/G/B three-in-one LEDs in the related art. In the above, an anode of each 6-pin R/G/B three-in-one LED in FIG. 2b has three pins, i.e. 1, 2 and 3 respectively, corresponding to anodes of internal R/G/B, and a cathode of each 6-pin R/G/B three-in-one LED has three pins, i.e. 4, 5 and 6 respectively, corresponding to cathodes of internal R/G/B respectively; the LED unit board consists of an LED matrix with M lines and N columns, the anodes of the LEDs in a single line are interconnected to the drains of the P-MOS transistors, and cathodes of common primary color LEDs of the LED particles in a single column are interconnected to constant current input ends of the LED driving circuit; the sources of the P-MOS transistors are connected to the power supply end VCC, the gates of the P-MOS transistors are connected to a power supply control logic part of the display driving circuit 30′, and the drains of the P-MOS transistors are connected to the anodes of a group of LEDs (The LEDs shown in the figure are LEDs in a single line, and the definition of the group is not purely defined as a line actually) of the LED unit board; the control end of the LED driving circuit is connected with a branch of the LED driving circuit control part, and a driving current for switching on the LEDs flows through the input end of the LED driving circuit and the output ends of the LED driving circuits to reach the GND from the cathodes (pins 4, 5 and 6) of the LEDs; and the display driving circuit 30′ includes a line power supply control logic part and the LED driving circuit control part, and under the control of the display driving circuit 30′, the display work of the LED unit board is realized.

FIG. 3a to FIG. 3c are discrete placement circuit diagrams of an LED driving circuit for R/G/B independent LEDs in the related art. As shown in FIG. 3b, an anode of an R/G/B independent LED particle is pin 1, a cathode of the R/G/B independent LED particle is pin 2, and R/G/B are welded in parallel to form a full-color pixel in the application; the LED unit board consists of an LED matrix with M lines and N columns, the anodes of the LEDs in a single line are interconnected to the drains of the P-MOS transistors, and cathodes of common primary color LEDs of the LED particles in a single column are interconnected to constant current input ends of the LED driving circuit; the sources of the P-MOS transistors are connected to the power supply end VCC, the gates of the P-MOS transistors are connected to the power supply control logic part of the display driving circuit 30′, and the drains of the P-MOS transistors are connected to the anodes of a group of LEDs (The LEDs shown in the figure are LEDs in a single line, and the definition of the group is not purely defined as a line actually) of the LED unit board; the control end of the LED driving circuit is connected with a branch of the LED driving circuit control part, and a driving current for switching on the LEDs flows through the input end of the LED driving circuit and the output ends of the LED driving control circuits to reach the GND from the cathodes (pin 2) of the LED particles; and the display driving circuit 30′ includes a line power supply control logic part and the LED driving circuit control part, and under the control of the display driving circuit 30′, the display work of the LED unit board is realized.

From the above, the R/G/B LEDs have different working voltages, wherein a typical working voltage of red LEDs is 1.8-2V, and typical working voltages of green/blue LEDs are 3.4-3.6V, in order to ensure that working voltages of the green/blue LEDs are normal, output voltages of the P-MOS transistors must be higher than the sum of the typical voltages of the green/blue LEDs and a typical constant current voltage of the LED driving circuit. Thus, voltage differences of the red LEDs relative to the green/blue LEDs(between the red LEDs and the green/blue LEDs) will be applied to the LED driving circuit to generate heat for dissipation(to be dissipated through the form of heat), which will cause high power consumption of the LED display. For the problem of large PCB area occupied by the control circuits of the LED display and low refreshing rate of the LED display in the related art, no effective solution has been proposed yet.

### SUMMARY

For the problem of large PCB area occupied by the control circuits of the LED display and low refreshing rate of the LED display in the related art, no effective solution has been proposed yet. Therefore, a main purpose of the disclosure is to provide an LED display and an LED control system, so as to solve above problem.

In order to realize the purpose, according to one aspect of the disclosure, an LED display is provided, which includes: an LED display panel; and a display driving circuit, including a switching circuit, a driving circuit and a control circuit, wherein a first end of one of the switching circuit and the driving circuit is connected to a power end of a power supply equipment, and a first end of the other of the switching circuit and the driving circuit is connected to a grounding end of the power supply equipment; a second end of one of the switching circuit and the driving circuit is connected with an anode of the LED display panel, and a second end of the other of the switching circuit and the driving circuit is connected with a cathode of the LED display panel; the control circuit includes a power supply control circuit and a driving control circuit; wherein the power supply control circuit is connected with a third end of the switching circuit through a power supply control port, and is configured to control the switching-on or switching-off of the switching circuit; the driving control circuit is connected with a third end of the driving circuit through a driving control port, and is configured to control the conducting or cutting-off of the driving circuit; and wherein the switching circuit is configured to control the power supply of the LED display panel, and the driving circuit is configured to control the ordered display of the LED display panel.

Furthermore, the switching circuit includes a switching sub-circuit, and the switching sub-circuit includes one or more field effect transistors, wherein a source of each of the field effect transistors is connected with the power end or grounding end of the power supply equipment respectively; a drain of each of the field effect transistors is connected with an anode or cathode of each LED particle in a corresponding line in the LED display panel respectively; and a gate of each of the field effect transistors is connected with a corresponding connection terminal in the power supply control port respectively.

Furthermore, the driving circuit includes a constant current channel group, and the constant current channel group includes one or more constant current logic components, wherein a first end of each of the constant current logic components is connected with the power end or grounding end of the power supply equipment respectively; a second end of each of the constant current logic components is connected with an anode or cathode of an LED particle in a corresponding column in the LED display panel respectively; and a third end of each of the constant current logic components is connected with a corresponding connection terminal in the driving control port respectively.

Furthermore, the power supply control circuit is configured to control each of the field effect transistors to be switched on to supply power to LED particles in a line corresponding to the each of the field effect transistors in the LED display panel; and the driving control circuit is configured to control each of the constant current logic components in the constant current channel group to be turned on, and each of the constant current logic components provides a current path for LED particles in a column corresponding to the each of the constant current logic components in the LED display panel respectively to control the ordered display of the LED particles after being turned on.

Furthermore, the field effect transistors are P-channel Metal Oxide Semiconductor (P-MOS) transistors, the LED display panel includes LED particles with M lines and N columns, and each of the LED particles respectively includes a red lamp tube, a green lamp tube and a blue lamp tube, wherein an anode of the red lamp tube, an anode of the green lamp tube and an anode of the blue lamp tube in the ith LED particle in each line are connected in parallel with the ith joint, and each joint in each line is connected in parallel, and is connected with a drain of corresponding one of the P-MOS transistors in the switching circuit respectively; a cathode of the red lamp tube of each of the LED particles in each column is connected in parallel respectively, and is connected with a second end of corresponding one of the constant current logic components in the constant current channel group respectively; a cathode of the green lamp tube of each of the LED particles in each column is connected in parallel respectively, and is connected with a second end of corresponding one of the constant current logic components in the constant current channel group respectively; and a cathode of the blue lamp tube of each of the LED particles in each column is connected in parallel respectively, and is connected with a second end of corresponding one of the constant current logic components in the constant current channel group respectively.

Furthermore, the field effect transistors are P-MOS transistors, the LED display panel includes LED particles with M lines and N columns, and each LED of the particle respectively includes a red lamp tube, a green lamp tube and a blue lamp tube, wherein an anode of the red lamp tube, an anode of the green lamp tube and an anode of the blue lamp tube in each of the LED particles in each line are connected in parallel, and are connected with a drain of corresponding one of the P-MOS transistors in the switching circuit; a cathode of the red lamp tube of each of the LED particles in each column is connected in parallel respectively, and is connected with a second end of corresponding one of the constant current logic components in the constant current channel group respectively; a cathode of the green lamp tube of each of the LED particles in each column is connected in parallel respectively, and is connected with a second end of corresponding one of the constant current logic components in the constant current channel group respectively; and a cathode of the blue lamp tube of each of the LED particles in each column is connected in parallel respectively, and is connected with a second end of corresponding one of the constant current logic components in the constant current channel group respectively.

Furthermore, the field effect transistors are N-channel Metal Oxide Semiconductor (N-MOS) transistors, the LED display panel includes LED particles with M lines and N columns, and each of the LED particles respectively includes a red lamp tube, a green lamp tube and a blue lamp tube, wherein a cathode of the red lamp tube, a cathode of the green lamp tube and a cathode of the blue lamp tube in the ith LED particle in each line are connected in parallel with the ith joint, and each joint in each line is connected in parallel, and is connected with a drain of corresponding one of the N-MOS transistors in the switching circuit; an anode of the red lamp tube of each of the LED particles in each column is connected in parallel respectively, and is connected with a second end of corresponding one of the constant current logic components in the constant current channel group respectively; an anode of the green lamp tube of each of the LED particles in each column is connected in parallel respectively, and is connected with a second end of corresponding one of the constant current logic components in the constant current channel group respectively; and an anode of the blue lamp tube of each of the LED particles in each column is connected in parallel respectively, and is connected with a second end of corresponding one of the constant current logic components in the constant current channel group respectively.

Furthermore, the field effect transistors are N-MOS transistors, the LED display panel includes LED particles with M lines and N columns, and each of the LED particles respectively includes a red lamp tube, a green lamp tube and a blue lamp tube, wherein a cathode of the red lamp tube, a cathode of the green lamp tube and a cathode of the blue lamp tube in each of the LED particles in each line are connected in parallel, and are connected with a drain of corresponding one of the N-MOS transistors in the switching circuit; an anode of the red lamp tube of each of the LED particles in each column is connected in parallel respectively, and is connected with a second end of corresponding one of the constant current logic components in the constant current channel group respectively; an anode of the green lamp tube of each of the LED particles in each column is connected in parallel respectively, and is connected with a second end of corresponding one of the constant current logic components in the constant current channel group respectively; and an anode of the blue lamp tube of each of the LED particles in each column is connected in parallel respectively, and is connected with a second end of corresponding one of the constant current logic components in the constant current channel group respectively.

Furthermore, the driving circuit includes a first constant current channel group, a second constant current channel group and a third constant current channel group, wherein the first constant current channel group comprises one or more constant current logic components, wherein a first end of each of the constant current logic components is respectively connected with the power end or grounding end of the power supply equipment, a third end of each of the constant current logic components is respectively connected with a first R display control sub-port of the driving control port, and a second end of each of the constant current logic components is respectively connected with the anode or cathode of the red lamp tube in each of the LED particles in a corresponding column in the LED display panel, for controlling the display of red lamp tubes of the LED display panel; the second constant current channel group comprises one or more constant current logic components, wherein a first end of each of the constant current logic components is respectively connected with the power end or grounding end of the power supply equipment, a third end of each of the constant current logic components is respectively connected with a first G display control sub-port of the driving control port, and a second end of each of the constant current logic components is respectively connected with the anode or cathode of the green lamp tube in each of the LED particles in a corresponding column in the LED display panel, for controlling the display of green lamp tubes of the LED display panel; and the third constant current channel group comprises one or more constant current logic components, a first end of each of the constant current logic components is respectively connected with the power end or grounding end of the power supply equipment, a third end of each of the constant current logic components is respectively connected with a first B display control sub-port of the driving control port, and a second end of each of the constant current logic components is respectively connected with the anode or cathode of the blue lamp tube in each of the LED particles in a corresponding column in the LED display panel, for controlling the display of blue lamp tubes of the LED display panel.

Furthermore, the power supply control circuit controls each of the field effect transistors to be switched on to supply power to the LED particles in lines corresponding to the field effect transistors in the LED display panel; the driving control circuit is configured to control each of the constant current logic components in the first constant current channel group to be turned on through the first R display control sub-port, and each of the constant current logic components is turned on to respectively provide a current path for the red lamp tubes in the LED particles in the column corresponding to the constant current logic component in the LED display panel, so as to control the display of the red lamp tubes of the LED particles in the line corresponding to the field effect transistor in the LED display panel; the driving control circuit is further configured to control each of the constant current logic components in the second constant current channel group to be turned on through the first G display control sub-port, and each of the constant current logic components is turned on to respectively provide a current path for the green lamp tubes in the LED particles in the column corresponding to the constant current logic component in the LED display panel, so as to control the display of the green lamp tubes of the LED particles in the line corresponding to the field effect transistor in the LED display panel; and the driving control circuit is further configured to control each of the constant current logic components in the third constant current channel group to be turned on through the first B display control sub-port, and each of the constant current logic components is turned on to respectively provide a current path for the blue lamp tubes in the LED particles in the column corresponding to the constant current logic component in the LED display panel, so as to control the display of the blue lamp tubes of the LED particles in the line corresponding to the field effect transistor in the LED display panel.

Furthermore, the field effect transistors are P-MOS transistors, the LED display panel includes LED particles with M lines and N columns, and each of the LED particles includes a red lamp tube, a green lamp tube and a blue lamp tube respectively, wherein an anode of the red lamp tube, an anode of the green lamp tube and an anode of the blue lamp tube in the ith LED particle in each line are connected in parallel with the ith joint, and each joint in each line is connected in parallel, and is connected with a drain of corresponding one of the P-MOS transistors in the switching circuit respectively; a cathode of the red lamp tube of each of the LED particles in each column is connected in parallel respectively, and is connected with a second end of corresponding one of the constant current logic components in the first constant current channel group respectively; a cathode of the green lamp tube of each of the LED particles in each column is connected in parallel respectively, and is connected with a second end of corresponding one of the constant current logic components in the second constant current channel group respectively; and a cathode of the blue lamp tube of each of the LED particles in each column is connected in parallel respectively, and is connected with a second end of corresponding one of the constant current logic components in the third constant current channel group respectively.

Furthermore, the field effect transistors are P-MOS transistors, the LED display panel includes LED particles with M lines and N columns, and each of the LED particles includes a red lamp tube, a green lamp tube and a blue lamp tube respectively, wherein an anode of the red lamp tube, an anode of the green lamp tube and an anode of the blue lamp tube in each of the LED particles in each line are connected in parallel, and are connected with a drain of corresponding one of the P-MOS transistors in the switching circuit respectively; a cathode of the red lamp tube of each of the LED particles in each column is connected in parallel respectively, and is connected with a second end of corresponding one of the constant current logic components in the first constant current channel group respectively; a cathode of the green lamp tube of each of the LED particles in each column is connected in parallel respectively, and is connected with a second end of corresponding one of the constant current logic components in the second constant current channel group respectively; and a cathode of the blue lamp tube of each of the LED particles in each column is connected in parallel respectively, and is connected with a second end of corresponding one of the constant current logic components in the third constant current channel group respectively.

Furthermore, the field effect transistors are N-MOS transistors, the LED display panel includes LED particles with M lines and N columns, and each of the LED particles includes a red lamp tube, a green lamp tube and a blue lamp tube respectively, wherein a cathode of the red lamp tube, a cathode of the green lamp tube and a cathode of the blue lamp tube in the ith LED particle in each line are connected in parallel with the ith joint, and each joint in each line is connected in parallel, and is connected with a drain of corresponding one of the N-MOS transistors in the switching circuit respectively; an anode of the red lamp tube of each of the LED particles in each column is connected in parallel respectively, and is connected with a second end of corresponding one of the constant current logic components in the first constant current channel group respectively as a connection terminal of the anode of the LED display panel; an anode of the green lamp tube of each of the LED particles in each column is connected in parallel respectively, and is connected with a second end of corresponding one of the constant current logic components in the second constant current channel group respectively as a connection terminal of the anode of the LED display panel; and an anode of the blue lamp tube of each of the LED particles in each column is connected in parallel respectively, and is connected with a second end of corresponding one of the constant current logic components in the third constant current channel group respectively as a connection terminal of the anode of the LED display panel.

Furthermore, the field effect transistors are N-MOS transistors, the LED display panel includes LED particles with M lines and N columns, and each of the LED particles includes a red lamp tube, a green lamp tube and a blue lamp tube respectively, wherein a cathode of the red lamp tube, a cathode of the green lamp tube and a cathode of the blue lamp tube in each of the LED particles in each line are connected in parallel, and are connected with a drain of corresponding one of the N-MOS transistors in the switching circuit respectively; an anode of the red lamp tube of each of the LED particles in each column is connected in parallel respectively, and is connected with a second end of corresponding one of the constant current logic components in the first constant current channel group respectively; an anode of the green lamp tube of each of the LED particles in each column is connected in parallel respectively, and is connected with a second end of corresponding one of the constant current logic components in the second constant current channel group respectively; and an anode of the blue lamp tube of each of the LED particles in each column is connected in parallel respectively, and is connected with a second end of corresponding one of the constant current logic components in the third constant current channel group respectively.

Furthermore, the switching circuit includes a first switching sub-circuit and a second switching sub-circuit, wherein e each of the first switching sub-circuit and the second switching sub-circuit comprises one or more field effect transistors; and a source of each of the field effect transistors in the first switching sub-circuit and the second switching sub-circuit is connected with the power end or grounding end of the power supply equipment respectively; wherein a drain of each of the field effect transistors in the first switching sub-circuit is respectively connected with an anode or cathode of the red lamp tube in each of the LED particles in a corresponding line in the LED display panel, and a gate of each of the field effect transistors is respectively connected with a corresponding connection terminal in the power supply control port, for controlling the power supply of the red lamp tube of the LED display panel; and a drain of each of the field effect transistors in the second switching sub-circuit is respectively connected with an anode or cathode of the green lamp tube and the blue lamp tube in each of the LED particles in a corresponding line in the LED display panel, and a gate of each of the field effect transistors is respectively connected with a corresponding connection terminal in the power supply control port, for controlling the power supply of the green lamp tube and the blue lamp tube of the LED display panel.

Furthermore, the driving circuit includes a constant current channel group, and the constant current channel group includes: one or more constant current logic components, wherein a first end of each of the constant current logic components is connected with the power end or grounding end of the power supply equipment respectively; a second end of each of the constant current logic components is connected with an anode or cathode of the LED particles in a corresponding column in the LED display panel respectively; and a third end of each of the constant current logic components is connected with a corresponding connection terminal in the driving control port respectively.

Furthermore, the power supply control circuit is configured to control one of the field effect transistors in the first switching sub-circuit to be switched on to supply power to red lamp tubes in LED particles in a line corresponding to the one of the field effect transistors in the first switching sub-circuit in the LED display panel; the power supply control circuit is further configured to control a field effect transistor, which corresponds to the one of the field effect transistors in the first switching sub-circuit, in the second switching sub-circuit to be switched on to supply power to the green lamp tubes and the blue lamp tubes in the LED particles in a line, which corresponds to the one of the field effect transistors in the first switching sub-circuit, in the LED display panel; and the driving control circuit is configured to control each of the constant current logic components in the constant current channel group to be turned on, and each of the constant current logic components provides a current path for the LED particles in a column corresponding to the constant current logic component in the LED display panel respectively after the each of the constant current logic components is turned on, so as to control the ordered display of the LED particles in the line corresponding to the field effect transistor in the LED display panel.

Furthermore, the field effect transistors are P-MOS transistors, the LED display panel includes LED particles with M lines and N columns, and each of the LED particles respectively includes a red lamp tube, a green lamp tube and a blue lamp tube, wherein an anode of the red lamp tube in the ith LED particle in each line is connected in parallel with the ith joint, and each joint in each line is connected in parallel, and is connected with a drain of corresponding one of the P-MOS transistors in the first switching sub-circuit respectively; an anode of the green lamp tube and an anode of the blue lamp tube in the jth LED particle in each line are connected in parallel with the jth joint, and each joint in each line is connected in parallel, and is connected with a drain of corresponding one of the P-MOS transistors in the second switching sub-circuit respectively; a cathode of the red lamp tube of each of the LED particles in each column is connected in parallel respectively, and is connected with a second end of corresponding one of the constant current logic components in the constant current channel group respectively; a cathode of the green lamp tube of each of the LED particles in each column is connected in parallel respectively, and is connected with a second end of corresponding one of the constant current logic components in the constant current channel group respectively; and a cathode of the blue lamp tube of each of the LED particles in each column is connected in parallel respectively, and is connected with a second end of corresponding one of the constant current logic components in the constant current channel group respectively.

Furthermore, the field effect transistors are P-MOS transistors, the LED display panel includes LED particles with M lines and N columns, and each of the LED particles includes a red lamp tube, a green lamp tube and a blue lamp tube, wherein an anode of the red lamp tube in each of the LED particles in each line is connected in parallel, and is connected with a drain of corresponding one of the P-MOS transistors in the first switching sub-circuit respectively; an anode of the green lamp tube and an anode of the blue lamp tube in each of the LED particles in each line are connected in parallel, and are connected with a drain of corresponding one of the P-MOS transistors in the second switching sub-circuit respectively; a cathode of the red lamp tube of each of the LED particles in each column is connected in parallel respectively, and is connected with a second end of corresponding one of the constant current logic components in the constant current channel group respectively; a cathode of the green lamp tube of each of the LED particles in each column is connected in parallel respectively, and is connected with a second end of corresponding one of the constant current logic components in the constant current channel group respectively; and a cathode of the blue lamp tube of each of the LED particles in each column is connected in parallel respectively, and is connected with a second end of corresponding one of the constant current logic components in the constant current channel group respectively.

Furthermore, the field effect transistors are N-MOS transistors, the LED display panel includes LED particles with M lines and N columns, and each of the LED particles respectively includes a red lamp tube, a green lamp tube and a blue lamp tube, wherein a cathode of the red lamp tube in the ith LED particle in each line is connected in parallel with the ith joint, and each joint in each line is connected in parallel, and is connected with a drain of corresponding one of the N-MOS transistors in the first switching sub-circuit respectively; a cathode of the green lamp tube and a cathode of the blue lamp tube in the jth LED particle in each line are connected in parallel with the jth joint, and each joint in each line is connected in parallel, and is connected with a drain of corresponding one of the N-MOS transistors in the second switching sub-circuit respectively; an anode of the red lamp tube of each of the LED particles in each column is connected in parallel respectively, and is connected with a second end of corresponding one of the constant current logic components in the constant current channel group respectively; an anode of the green lamp tube of each of the LED particles in each column is connected in parallel respectively, and is connected with a second end of corresponding one of the constant current logic components in the constant current channel group respectively; and an anode of the blue lamp tube of each of the LED particles in each column is connected in parallel respectively, and is connected with a second end of corresponding one of the constant current logic components in the constant current channel group respectively.

Furthermore, the field effect transistors are N-MOS transistors, the LED display panel includes LED particles with M lines and N columns, and each of the LED particles includes a red lamp tube, a green lamp tube and a blue lamp tube, wherein a cathode of the red lamp tube in each of the LED particles in each line is connected in parallel, and is connected with a drain of corresponding one of the N-MOS transistors in the first switching sub-circuit respectively; a cathode of the green lamp tube and a cathode of the blue lamp tube in each of the LED particles in each line are connected in parallel, and are connected with a drain of corresponding one of the N-MOS transistors in the second switching sub-circuit respectively; an anode of the red lamp tube of each of the LED particles in each column is connected in parallel respectively, and is connected with a second end of corresponding one of the constant current logic components in the constant current channel group respectively; an anode of the green lamp tube of each of the LED particles in each column is connected in parallel respectively, and is connected with a second end of corresponding one of the constant current logic components in the constant current channel group respectively; and an anode of the blue lamp tube of each of the LED particles in each column is connected in parallel respectively, and is connected with a second end of corresponding one of the constant current logic components in the constant current channel group respectively.

Furthermore, the driving circuit includes a first constant current channel group, a second constant current channel group and a third constant current channel group, wherein the first constant current channel group comprises one or more constant current logic components, wherein a first end of each of the constant current logic components is connected with the power end or grounding end of the power supply equipment respectively, a third end of each of the constant current logic components is connected with a second R display control sub-port of the driving control port respectively, and a second end of each of the constant current logic components is connected with an anode or cathode of the red lamp tube in each of the LED particles in a corresponding column in the LED display panel respectively, for controlling the display of the red lamp tube of the LED display panel; the second constant current channel group comprises one or more constant current logic components, wherein a first end of each of the constant current logic components is connected with the power end or grounding end of the power supply equipment respectively, a third end of each of the constant current logic components is connected with a second G display control sub-port of the driving control port respectively, and a second end of each of the constant current logic components is connected with an anode or cathode of the green lamp tube in each of the LED particles in a corresponding column in the LED display panel respectively, for controlling the display of the green lamp tube of the LED display panel; and the third constant current channel group comprises one or more constant current logic components, wherein a first end of each of the constant current logic components is connected with the power end or grounding end of the power supply equipment respectively, a third end of each of the constant current logic components is connected with a second B display control sub-port of the driving control port respectively, and a second end of each of the constant current logic components is connected with an anode or cathode of the blue lamp tube in each of the LED particles in a corresponding column in the LED display panel respectively, for controlling the display of the blue lamp tube of the LED display panel.

Furthermore, the power supply control circuit is configured to control one of the field effect transistors in the first switching sub-circuit to be switched on to supply power to the red lamp tubes in the LED particles in a line, which corresponds to the one of the field effect transistors in the first switching sub-circuit, in the LED display panel; the power supply control circuit is further configured to control a field effect transistor, which corresponds to the one of the field effect transistors in the first switching sub-circuit, in the second switching sub-circuit to be switched on to supply power to the green lamp tubes and the blue lamp tubes in the LED particles in a line, which corresponds to the field effect transistor in the first switching sub-circuit, in the LED display panel; the driving control circuit is configured to control each of the constant current logic components in the first constant current channel group to be turned on through the second R display control sub-port, and each of the constant current logic components provides a current path for the red lamp tubes in the LED particles in the column corresponding to the constant current logic component in the LED display panel respectively after the each of the constant current logic components is turned on, so as to control the display of the red lamp tubes of the LED particles in the line corresponding to the field effect transistor in the LED display panel; the driving control circuit is further configured to control each of the constant current logic components in the second constant current channel group to be turned on through the second G display control sub-port, and each of the constant current logic components provides a current path for the green lamp tubes in the LED particles in the column corresponding to the constant current logic component in the LED display panel respectively after the each of the constant current logic components is turned on, so as to control the display of the green lamp tubes of the LED particles in the line corresponding to the field effect transistor in the LED display panel; and the driving control circuit is further configured to control each of the constant current logic components in the third constant current channel group to be turned on through the second B display control sub-port, and each of the constant current logic components provides a current path for the blue lamp tubes in the LED particles in the column corresponding to the constant current logic component in the LED display panel respectively after the each of the constant current logic components is turned on, so as to control the display of the blue lamp tubes of the LED particles in the line corresponding to the field effect transistor in the LED display panel.

Furthermore, the field effect transistors are P-MOS transistors, the LED display panel includes LED particles with M lines and N columns, and each of the LED particles respectively includes a red lamp tube, a green lamp tube and a blue lamp tube, wherein an anode of the red lamp tube in the ith LED particle in each line is connected in parallel with the ith joint, and each joint in each line is connected in parallel, and is connected with a drain of corresponding one of the P-MOS transistors in the first switching sub-circuit; an anode of the green lamp tube and an anode of the blue lamp tube in the jth LED particle in each line are connected in parallel with the jth joint, and each joint in each line is connected in parallel, and is connected with a drain of corresponding one of the P-MOS transistors in the second switching sub-circuit respectively; a cathode of the red lamp tube of each of the LED particles in each column is connected in parallel respectively, and is connected with a second end of corresponding one of the constant current logic components in the first constant current channel group respectively; a cathode of the green lamp tube of each of the LED particles in each column is connected in parallel respectively, and is connected with a second end of corresponding one of the constant current logic components in the second constant current channel group respectively; and a cathode of the blue lamp tube of each of the LED particles in each column is connected in parallel respectively, and is connected with a second end of corresponding one of the constant current logic components in the third constant current channel group respectively.

Furthermore, the field effect transistors are P-MOS transistors, the LED display panel includes LED particles with M lines and N columns, and each of the LED particles respectively includes an anode of the red lamp tube in each of the LED particles in each line is connected in parallel, and is connected with a drain of corresponding one of the P-MOS transistors in the first switching sub-circuit respectively; an anode of the green lamp tube and an anode of the blue lamp tube in each of the LED particles in each line are connected in parallel, and are connected with a drain of corresponding one of the P-MOS transistors in the second switching sub-circuit respectively as a connection terminal of the anode of the LED display panel; a cathode of the red lamp tube of each of the LED particles in each column is connected in parallel respectively, and is connected with a second end of corresponding one of the constant current logic components in the first constant current channel group respectively; a cathode of the green lamp tube of each of the LED particles in each column is connected in parallel respectively, and is connected with a second end of corresponding one of the constant current logic components in the second constant current channel group respectively; and a cathode of the blue lamp tube of each of the LED particles in each column is connected in parallel respectively, and is connected with a second end of corresponding one of the constant current logic components in the third constant current channel group respectively.

Furthermore, the field effect transistors are N-MOS transistors, the LED display panel includes LED particles with M lines and N columns, and each of the LED particles respectively includes a cathode of the red lamp tube in the ith LED particle in each line is connected in parallel with the ith joint, and each joint in each line is connected in parallel, and is connected with a drain of corresponding one of the N-MOS transistors in the first switching sub-circuit respectively; a cathode of the green lamp tube and a cathode of the blue lamp tube in the jth LED particle in each line are connected in parallel with the jth joint, and each joint in each line is connected in parallel, and is connected with a drain of corresponding one of the N-MOS transistors in the second switching sub-circuit respectively; an anode of the red lamp tube of each of the LED particles in each column is connected in parallel respectively, and is connected with a second end of corresponding one of the constant current logic components in the first constant current channel group respectively; an anode of the green lamp tube of each of the LED particles in each column is connected in parallel respectively, and is connected with a second end of corresponding one of the constant current logic components in the second constant current channel group respectively; and an anode of the blue lamp tube of each of the LED particles in each column is connected in parallel respectively, and is connected with a second end of corresponding one of the constant current logic components in the third constant current channel group respectively.

Furthermore, the field effect transistors are N-MOS transistors, the LED display panel includes LED particles with M lines and N columns, and each of the LED particles includes a red lamp tube, a green lamp tube and a blue lamp tube, wherein a cathode of the red lamp tube in each of the LED particles in each line is connected in parallel, and is connected with a drain of corresponding one of the N-MOS transistors in the first switching sub-circuit respectively; a cathode of the green lamp tube and a cathode of the blue lamp tube in each of the LED particles in each line are connected in parallel, and are connected with a drain of corresponding one of the N-MOS transistors in the second switching sub-circuit respectively; an anode of the red lamp tube of each of the LED particles in each column is connected in parallel respectively, and is connected with a second end of corresponding one of the constant current logic components in the first constant current channel group respectively; an anode of the green lamp tube of each of the LED particles in each column is connected in parallel respectively, and is connected with a second end of corresponding one of the constant current logic components in the second constant current channel group respectively; and an anode of the blue lamp tube of each of the LED particles in each column is connected in parallel respectively, and is connected with a second end of corresponding one of the constant current logic components in the third constant current channel group respectively.

Furthermore, there are a red lamp tube, a green lamp tube and a blue lamp tube comprised in a LED particle in the LED display panel, wherein the red lamp tube, the green lamp tube and the blue lamp tube are integrated in the LED particle; or the red lamp tube, the green lamp tube and the blue lamp tube are arranged in the LED particle after being independently encapsulated respectively.

In order to realize the purpose, according to the other aspect of the disclosure, an LED control system is provided, which includes: a display driving circuit, the display driving circuit including a switching circuit, a driving circuit and a control circuit, wherein a first end of one of the switching circuit and the driving circuit is connected to a power end of a power supply equipment, and a first end of the other of the switching circuit and the driving circuit is connected to a grounding end of the power supply equipment; a second end of one of the switching circuit and the driving circuit is connected with an anode of the LED display panel, and a second end of the other of the switching circuit and the driving circuit is connected with a cathode of the LED display panel; the control circuit comprises: a power supply control circuit and a driving control circuit; wherein the power supply control circuit is connected with a third end of the switching circuit through a power supply control port, and is configured to control the switching-on or switching-off of the switching circuit; the driving control circuit is connected with a third end of the driving circuit through a driving control port, and is configured to control the conducting or cutting-off of the driving circuit; and wherein the switching circuit is configured to control the power supply of the LED display panel, and the driving circuit is configured to control the ordered display of the LED display panel.

By the LED display and the LED control system of the embodiments of the invention, the switching circuit, the driving circuit and the control circuit are integrated in the display driving circuit, and then more display driving circuits can be placed under the condition of not changing an area of the LED display panel, so that a number ratio of the LED particles and the display driving circuits on the LED display with a fixed area is reduced, and a refreshing rate is increased; moreover, a connection relationship between the display driving circuits and an LED particle array with M lines*N columns in the LED display panel is clearer, fewer connection lines are required, and the design difficulty of the PCB is decreased. The problem of large PCB area occupied by the control circuits of the LED display and low refreshing rate of the LED display in the related art is solved, and the effects of small panel area occupied by the control circuits of the LED display, simple design and high refreshing rate of the LED display are realized.

### BRIEF DESCRIPTION OF THE DRAWINGS

The drawings are described here to provide further understanding of the disclosure, and form a part of the disclosure. The schematic embodiments and description of the disclosure are used to explain the disclosure, and do not form improper limits to the disclosure. In the drawings:

FIG. 1a is a discrete placement schematic diagram of an LED driving circuit of three-anode-in-one LED particles in the related art;

FIG. 1b is a partial enlarged drawing of a dashed part A in FIG. 1a;

FIG. 1c is a partial enlarged drawing of a dashed part A1 in FIG. 1b;

FIG. 2a is a discrete placement circuit schematic diagram of an LED driving circuit of 6-pins R/G/B three-in-one LEDs in the related art;

FIG. 2b is a partial enlarged drawing of a dashed part B in FIG. 2a;

FIG. 2c is a partial enlarged drawing of a dashed part B1 in FIG. 2b;

FIG. 3a is a discrete placement circuit schematic diagram of an LED driving circuit of R/G/B independent LEDs in the related art;

FIG. 3b is a partial enlarged drawing of a dashed part C in FIG. 3a;

FIG. 3c is a partial enlarged drawing of a dashed part C1 in FIG. 3b;

FIG. 4 is a structure schematic diagram of an LED display according to embodiment 1 of the invention;

FIG. 5a is a detailed structure schematic diagram of the LED display according to embodiment 1 of the invention;

FIG. 5b is a partial enlarged drawing of a dashed part D in FIG. 5a;

FIG. 5c is a partial enlarged drawing of a dashed part D1 in FIG. 5b;

FIG. 6a is a structure schematic diagram of an LED display according to embodiment 2 of the invention;

FIG. 6b is a partial enlarged drawing of a dashed part E in FIG. 6a;

FIG. 6c is a partial enlarged drawing of a dashed part E1 in FIG. 6b;

FIG. 7a is a structure schematic diagram of an LED display according to embodiment 3 of the invention;

FIG. 7b is a partial enlarged drawing of a dashed part F in FIG. 7a;

FIG. 7c is a partial enlarged drawing of a dashed part F1 in FIG. 7b;

FIG. 7d is a partial enlarged drawing of a dashed part G in FIG. 7a;

FIG. 7e is a partial enlarged drawing of a dashed part G1 in FIG. 7d;

FIG. 8a is a structure schematic diagram of an LED display according to embodiment 4 of the invention;

FIG. 8b is a partial enlarged drawing of a dashed part H in FIG. 8a;

FIG. 8c is a partial enlarged drawing of a dashed part H1 in FIG. 8b;

FIG. 9a is a structure schematic diagram of an LED display according to embodiment 5 of the invention;

FIG. 9b is a partial enlarged drawing of a dashed part I in FIG. 9a;

FIG. 9c is a partial enlarged drawing of a dashed part I1 in FIG. 9b;

FIG. 10a is a structure schematic diagram of an LED display according to embodiment 6 of the invention;

FIG. 10b is a partial enlarged drawing of a dashed part J in FIG. 10a;

FIG. 10c is a partial enlarged drawing of a dashed part J1 in FIG. 10b;

FIG. 10d is a partial enlarged drawing of a dashed part K in FIG. 10a;

FIG. 10e is a partial enlarged drawing of a dashed part K1 in FIG. 10d; and

FIG. 11 is a structure schematic diagram of an LED control system according to an embodiment of the invention.

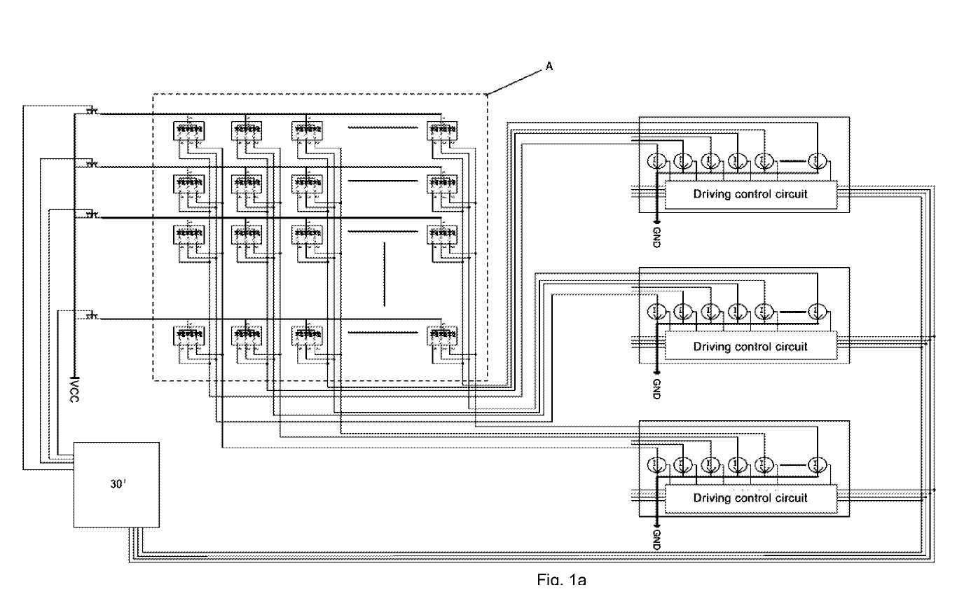

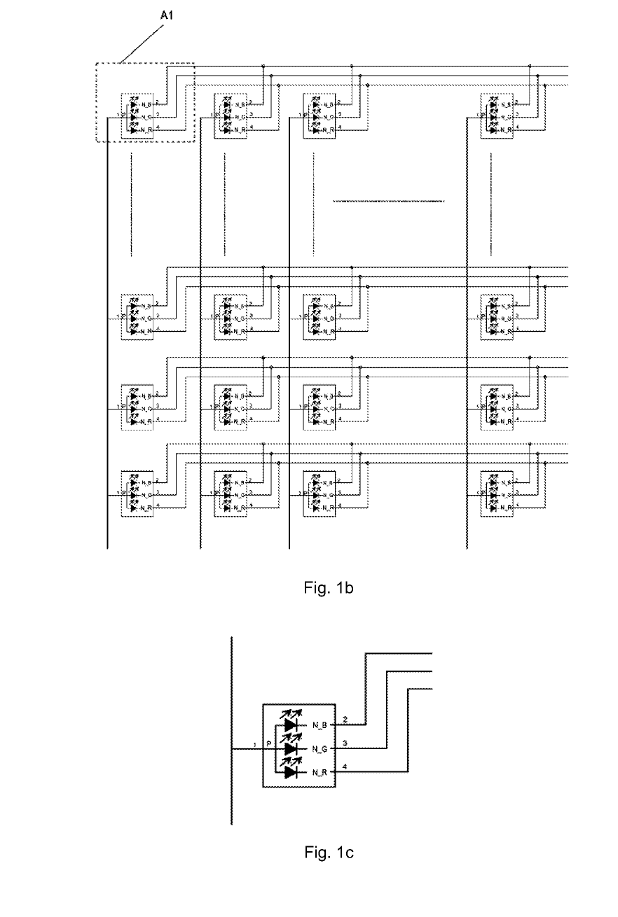

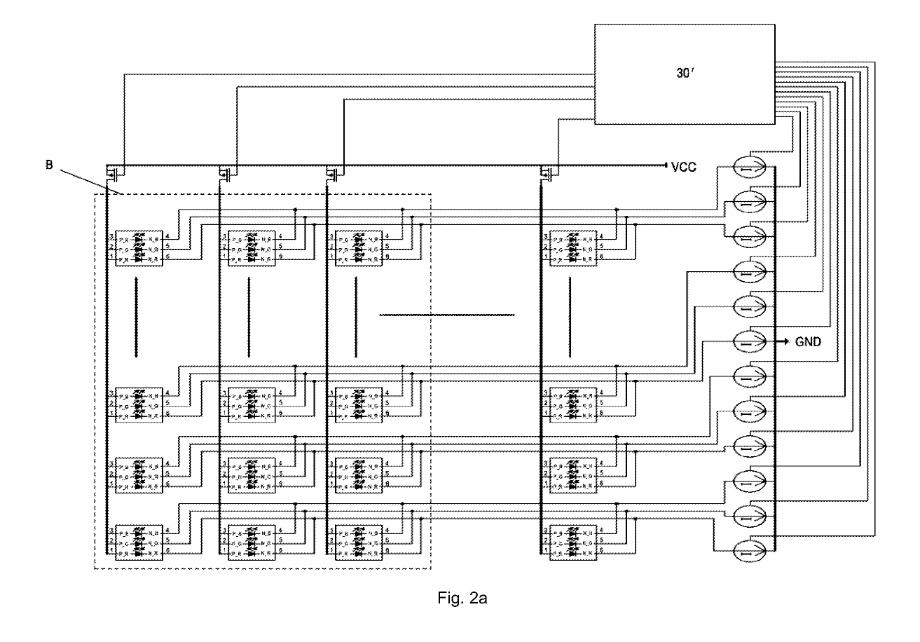

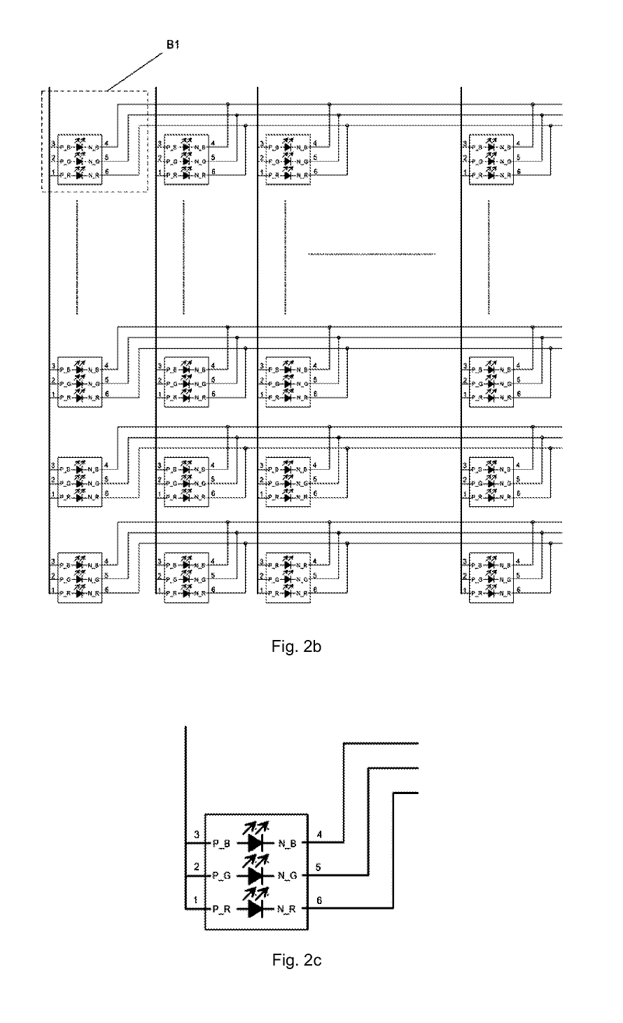

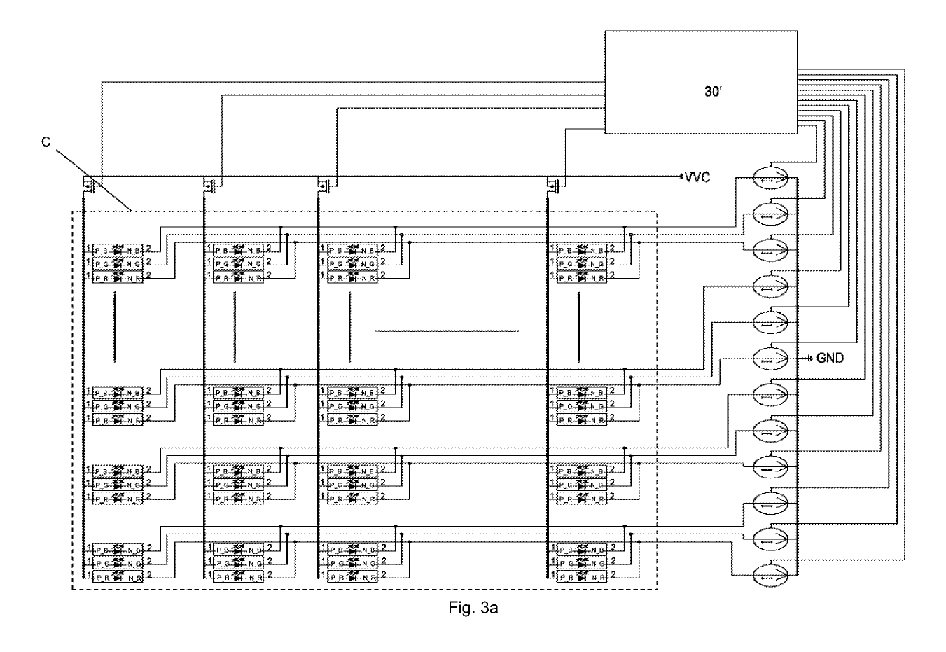

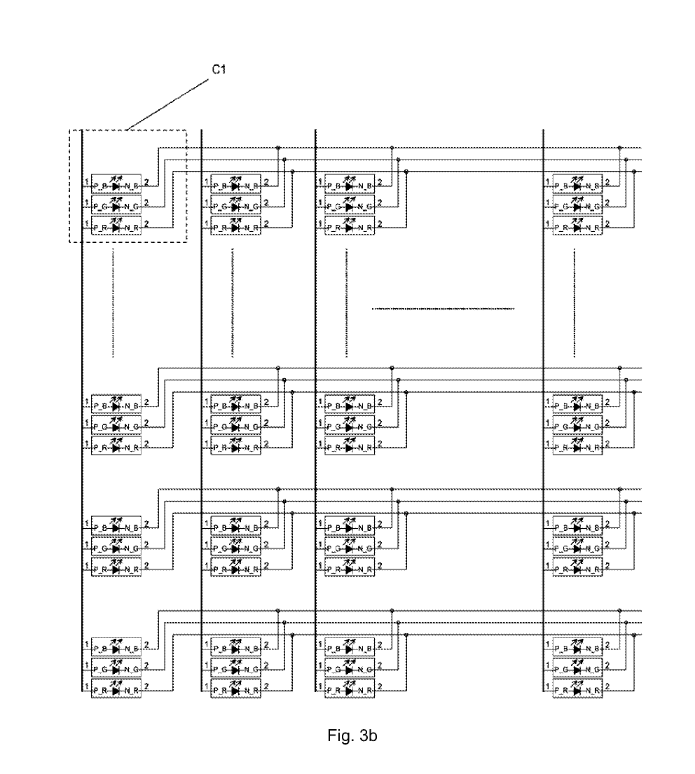

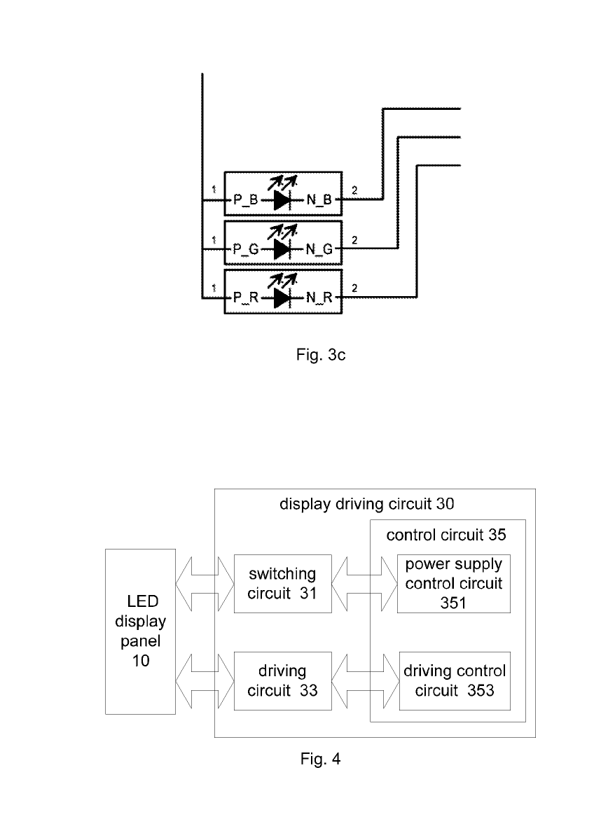

### DETAILED DESCRIPTION OF THE EMBODIMENTS

It should be noted that the embodiments of the invention and the characteristics in the embodiments can be combined under the condition of no conflicts. The disclosure will be descried as below in detail with reference to the drawings and embodiments.

### Embodiment 1

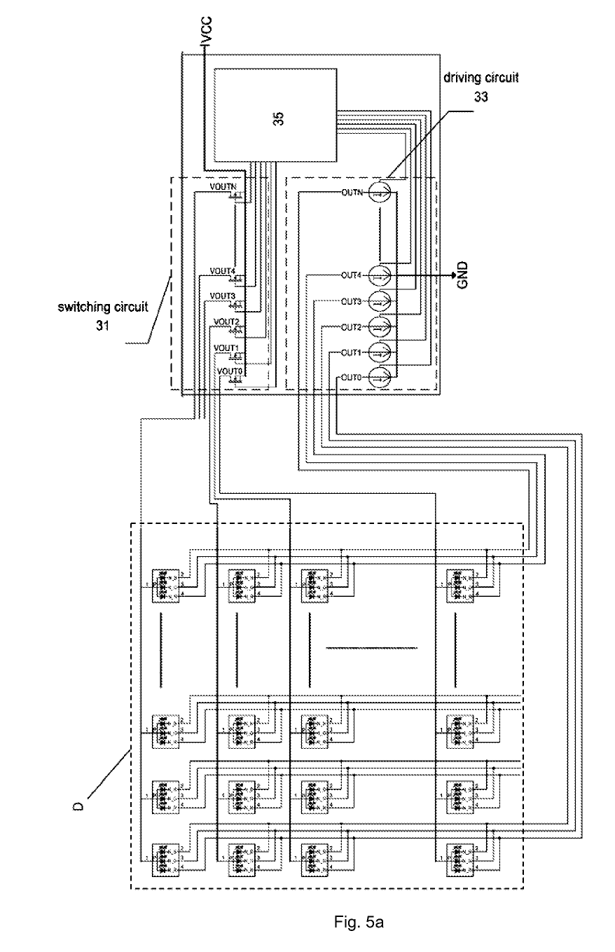

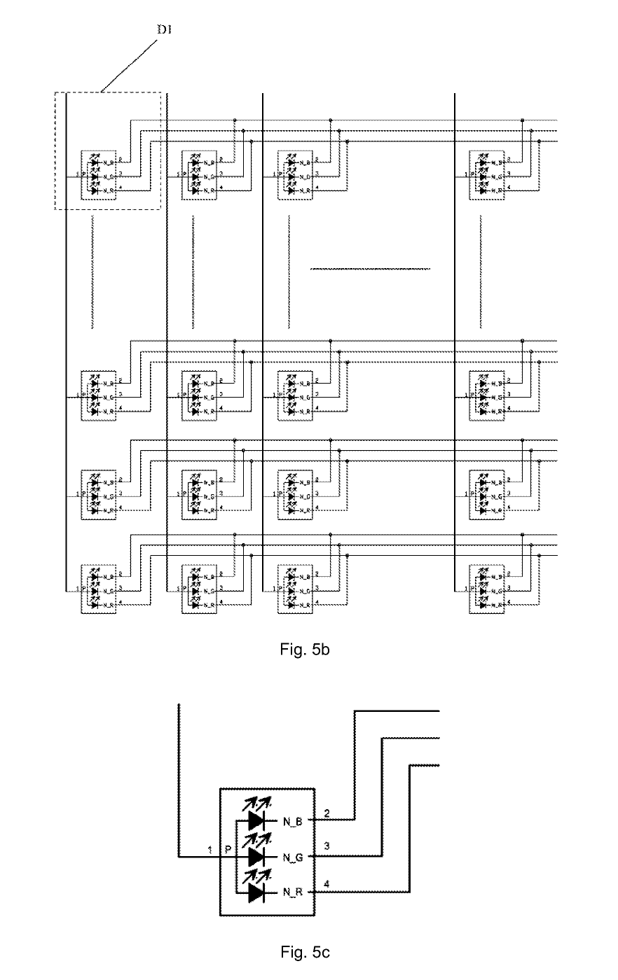

FIG. 4 is a structure schematic diagram of an LED display according to embodiment 1 of the invention; and FIG. 5a to FIG. 5c are detailed structure schematic diagrams of the LED display according to embodiment 1 of the invention. As shown in FIG. 4, FIG. 5a, FIG. 5b and FIG. 5c, the LED display includes: an LED display panel 10; and a display driving circuit 30, including a switching circuit 31, a driving circuit 33 and a control circuit 35, wherein a first end of one of the switching circuit 31 and the driving circuit 33 is connected to a power end of a power supply equipment, and a first end of the other of the switching circuit 31 and the driving circuit 33 is connected to a grounding end of the power supply equipment; a second end of one of the switching circuit 31 and the driving circuit 33 is connected with an anode of the LED display panel 10, and a second end of the other of the switching circuit 31 and the driving circuit 33 is connected with a cathode of the LED display panel 10; the control circuit 35 includes: a power supply control circuit 351 and a driving control circuit 353; wherein the power supply control circuit 351 is connected with a third end of the switching circuit 31 through a power supply control port, and is configured to control the switching-on or switching-off of the switching circuit 31; the driving control circuit 353 is connected with a third end of the driving circuit 33 through a driving control port, and is configured to control the turning-on or cutting-off of the driving circuit 33. In the above, the switching circuit 31 is configured to control the power supply of the LED display panel 10, and the driving circuit 33 is configured to control the ordered display of the LED display panel 10.

The LED display of the embodiment of the invention includes the LED display panel 10 and the display driving circuit 30, wherein the display driving circuit 30 includes the switching circuit 31, the driving circuit 33 and the control circuit 35; the control circuit includes the power supply control circuit 351 and the driving control circuit 353; the power supply control circuit 351 is configured to control the switching-on or switching-off of the switching circuit 31, and the driving control circuit 353 is configured to control the turning-on or cutting-off of the driving circuit 33; then the power supply of the LED display panel 10 is controlled by switching on or switching off the switching circuit 31 and the display of the LED display panel 10 is controlled by conducting or cutting off the driving circuit 33, thereby realizing the ordered display of the LED display panel 10. Through the LED display of the embodiment of the invention, the switching circuit 31, the driving circuit 33 and the control circuit 35 are integrated in the display driving circuit 30, and then more display driving circuits 30 can be placed under the condition of not changing an area of the LED display panel 10, so that a number ratio of LED particles and the display driving circuits 30 on the LED display with a fixed area is reduced, and a refreshing rate is increased; moreover, a connection relationship between the display driving circuits 30 and an LED particle array with M lines*N columns in the LED display panel 10 is clearer, fewer connection lines are required, and the design difficulty of the PCB is decreased. The problem of large PCB area occupied by the control circuit 35 and low refreshing rate of the LED display in the related art is solved, and the effects of small PCB area occupied by the control circuit 35, simple design and high refreshing rate of the LED display are realized.

In above embodiment of the invention, FIG. 5b is a partial enlarged drawing of a part D covered by a dashed line in FIG. 5a, the LED particle shown in FIG. 5c is a partial enlarged drawing of a part D1 covered by a dashed line in FIG. 5b, and in FIG. 5c, pin 1 is a common anode, and pins 2/3/4 are cathodes of B/G/R three primary colors LEDs respectively.

In the embodiment of the invention, the switching circuit 31 can include a switching sub-circuit, and the switching sub-circuit includes one or more field effect transistors, wherein a source of each of the field effect transistors is connected with the power end or grounding end of the power supply equipment respectively; a drain of each of the field effect transistors is connected with an anode or cathode of each of the LED particles in a corresponding line in the LED display panel 10 respectively; and a gate of each of the field effect transistors is connected with a corresponding connection terminal in the power supply control port respectively.

According to the embodiment of the invention, the driving circuit 33 can include a constant current channel group, and the constant current channel group includes one or more constant current logic components, wherein a first end of each of the constant current logic components is connected with the power end or grounding end of the power supply equipment respectively; a second end of each of the constant current logic components is connected with the anodes or cathodes of the LED particles in a corresponding column in the LED display panel 10 respectively; and a third end of each of the constant current logic components is connected with a corresponding connection terminal in the driving control port respectively.

Specifically, the power supply control circuit 351 is configured to control each field effect transistor to be switched on to supply power to the LED particles in a line corresponding to the field effect transistor in the LED display panel 10; and the driving control circuit 353 is configured to control each constant current logic component in the constant current channel group to be turned on, and each constant current logic component provides a current path for the LED particles in a column corresponding to the constant current logic component in the LED display panel 10 respectively after the each constant current logic component is turned on, so as to control the ordered display of the LED particles.

Specifically, the field effect transistors are P-MOS transistors, the LED display panel 10 includes M lines*N columns of LED particles, and each of the LED particles includes a red lamp tube, a green lamp tube and a blue lamp tube respectively, wherein an anode of the red lamp tube, an anode of the green lamp tube and an anode of the blue lamp tube in the ith LED particle in each line are connected in parallel with the ith joint, and each joint in each line is connected in parallel, and is connected with a drain of a corresponding P-MOS transistor in the switching circuit 31 respectively; a cathode of the red lamp tube of each LED particle in each column is connected in parallel respectively, and is connected with a second end of a corresponding constant current logic component in the constant current channel group respectively; a cathode of the green lamp tube of each LED particle in each column is connected in parallel respectively, and is connected with a second end of a corresponding constant current logic component in the constant current channel group respectively; and a cathode of the blue lamp tube of each LED particle in each column is connected in parallel respectively, and is connected with a second end of a corresponding constant current logic component in the constant current channel group respectively. In the above, 1≦i≦N, and i is a natural number, and the red lamp tube, the green lamp tube and the blue lamp tube can be the R/G/B primary color LEDs respectively.

The display driving circuit 30 includes a switching sub-circuit, the constant current channel group and the control circuit 35. The switching sub-circuit 31 includes N P-MOS transistors, wherein the drain of each P-MOS transistor serves as one of output pins of the control circuit 35, the source of each P-MOS transistor is connected to a power supply end (i.e. VCC end) of the display driving circuit 30, and the gate of each P-MOS transistor is connected with a connection terminal in the power supply control port of the control circuit 35; the constant current channel group can include N constant current logic components (which can also be called as constant current logic circuits), a second end (input end of the constant current logic component in the embodiment) of each constant current logic component serves as one of input pins of the display driving circuit 30 respectively, first ends (i.e. output ends) of all the constant current logic components are internally interconnected, and are connected with the grounding end of the power supply equipment as a grounding end (i.e. GND end) of the display driving circuit 30, and a third end (control end of the constant current logic components in the embodiment) of the constant current logic component is connected with the driving control port of the control circuit 35, and is configured to receive a constant current control signal of the driving circuit 33.

In embodiment 1, the LED display panel 10 (which can be called as an LED unit board) includes a matrix with M lines*N columns of LED particles, wherein the anodes of the LED particles in a single line are interconnected to the ith joint, each joint is connected to an output pin corresponding to the drain of one P-MOS transistor in the switching sub-circuit 31 in the switching circuit 31, and the cathodes of the LEDs in the same primary color in the LED particles in a single column are interconnected to an input end(s) of a constant current logic component(s) of the constant current channel group of the display driving circuit 30, that is, the common cathodes of the red lamp tubes (i.e. R LEDs) in the LED particles in a single column are interconnected to an input end of a constant current logic component of the constant current channel group of the display driving circuit 30; the common cathodes of the green lamp tubes (i.e. G primary color LEDs) in the LED particles in a single column are interconnected to an input end of a constant current logic component of the constant current channel group of the display driving circuit 30; and the common cathodes of the blue lamp tubs (i.e. B primary color LEDs) in the LED particles in a single column are interconnected to an input end of a constant current logic component of the constant current channel group of the display driving circuit 30.

In the case that the LED display panel 10 is under the control of the display driving circuit 30, the power supply control circuit 351 controls a certain P-MOS transistor in the switching sub-circuit (which can be the P-MOS channel group) to be in an turn-on state through the power supply control port to supply power to the anodes of the LED particles in a corresponding line on the LED display panel 10, and the driving control circuit 353 outputs a constant current control signal to each constant current logic component in the constant current channel group through the driving control port to control each constant current logic component to be in a turned on working state, thereby providing the current paths for the cathodes of the primary color LEDs of the LED particles in a corresponding column and realizing the ordered display of the LED unit board. In the above, the cathodes of the primary color LEDs of the LED particles in the corresponding column include the cathodes of the R, G and B three primary colors, that is, realizing the ordered display of the red lamp tubes, the green lamp tubes and the blue lamp tubes of the LED particles in the corresponding column respectively.

In the embodiment of the invention, the field effect transistors can be P-MOS transistors, the LED display panel 10 includes M lines*N columns of LED particles, and each LED particle includes a red lamp tube, a green lamp tube and a blue lamp tube, wherein the anode of the red lamp tube, the anode of the green lamp tube and the anode of the blue lamp tube in each LED particle in each line are connected in parallel, and are connected with a drain of a corresponding P-MOS transistor in the switching circuit 31; the cathode of the red lamp tube of each LED particle in each column is connected in parallel respectively, and is connected with a second end of a corresponding constant current logic component in the constant current channel group respectively; the cathode of the green lamp tube of each LED particle in each column is connected in parallel respectively, and is connected with a second end of a corresponding constant current logic component in the constant current channel group respectively; and the cathode of the blue lamp tube of each LED particle in each column is connected in parallel respectively, and is connected with a second end of a corresponding constant current logic component in the constant current channel group respectively.

Based on the technical solution shown in embodiment 1, there can be the first transformed implementation mode as follows:

the anodes of the R/G/B primary color LEDs of the LED particles in a single line in the LED display panel 10 are interconnected to an output pin corresponding to the drain of one P-MOS transistor in the switching circuit 31 in the display driving circuit 30, and the cathodes of the LEDs in the same primary color in the LED particles in a single column are interconnected to an input end(s) of the constant current logic component(s) of the constant current channel group of the display driving circuit 30, that is, the common cathodes of the R primary color LEDs in the LED particles in a single column are interconnected to an input end of the constant current logic component of the constant current channel group of the display driving circuit 30; the common cathodes of the G primary color LEDs in the LED particles in a single column are interconnected to an input end of the constant current logic component of the constant current channel group of the display driving circuit 30; and the common cathodes of the B primary color LEDs in the LED particles in a single column are interconnected to an input end of the constant current logic component of the constant current channel group of the display driving circuit 30.

In the transformed mode, a connection relationship between the anodes of the LED particles in a single line in the LED display panel 10 rather than a control mode of the display driving circuit 30 is changed, and in the transformed mode, the anodes of the R/G/B primary color LEDs of the LED particles in a single line are directly interconnected, and are connected to an output pin corresponding to the drain of one P-MOS transistor in the switching circuit. In the transformed mode, the switching circuit 31, the driving circuit 33 and the control circuit 35 are integrated in the display driving circuit 30, and then more display driving circuits 30 can be placed under the condition of not changing the area of the LED display panel 10, so that the number ratio of the LED particles and the display driving circuits 30 on the LED display with the fixed area is reduced, and the refreshing rate is increased; moreover, the connection relationship between the display driving circuits 30 and the LED particle array in the LED display panel 10 is clearer, fewer connection lines are required, and the design difficulty of the PCB is decreased.

Based on the technical solution shown in embodiment 1, there can also be the second transformed implementation mode as follows:

the field effect transistors can also be N-MOS transistors, the LED display panel 10 can include M lines*N columns of LED particles, and each LED particle includes a red lamp tube, a green lamp tube and a blue lamp tube respectively, wherein the cathode of the red lamp tube, the cathode of the green lamp tube and the cathode of the blue lamp tube in the ith LED particle in each line are connected in parallel with the ith joint, and each joint in each line is connected in parallel, and is connected with the drain of a corresponding N-MOS transistor in the switching circuit 31; the anode of the red lamp tube of each LED particle in each column is connected in parallel respectively, and is connected with a second end of a corresponding constant current logic component in the constant current channel group respectively; the anode of the green lamp tube of each LED particle in each column is connected in parallel respectively, and is connected with a second end of a corresponding constant current logic component in the constant current channel group respectively; and the anode of the blue lamp tube of each LED particle in each column is connected in parallel respectively, and is connected with a second end of a corresponding constant current logic component in the constant current channel group respectively. In the above, 1≦i≦N, and i is a natural number.

Specifically, in the second transformed mode, the switching sub-circuit includes N N-MOS transistors, wherein the drain of each N-MOS transistor serves as one of output pins of the control circuit 35 respectively, the source of the N-MOS transistor is connected with the grounding end of the power supply equipment as the grounding end (i.e. GND end) of the display driving circuit 30, and the gate of the N-MOS transistor is connected with a connection terminal in the power supply control port of the control circuit 35; the constant current channel group includes N constant current logic components (which can also be called as constant current logic circuits), a second end (i.e. input end) of each constant current logic component serves as one of the input pins of the display driving circuit 30 respectively, first ends (i.e. output ends) of all the constant current logic components are internally interconnected, and are connected with the power end of the power supply equipment as the power supply end (i.e. VCC end) of the display driving circuit 30, and a third end (i.e. control end) of the constant current logic component is connected with the display control port of the control circuit 35, and is configured to receive the constant current control signal of the driving circuit 33.

In the second transformed mode, the LED display panel 10 (which can also be called as an LED unit board) includes a matrix with M lines*N columns of LED particles, wherein the cathodes of the LED particles in a single line are interconnected to the ith joint, each joint is connected to an output pin corresponding to the drain of one N-MOS transistor in the switching circuit 31 in the display driving circuit 30, and the anodes of the LEDs in the same primary color in the LED particles in a single column are interconnected to an input end(s) of a constant current logic component(s) of the constant current channel group of the display driving circuit 30, that is, the common anodes of the R primary color LEDs in the LED particles in a single column is interconnected to an input end of a constant current logic component of the constant current channel group of the display driving circuit 30; the common anodes of the G primary color LEDs in the LED particles in a single column is interconnected to an input end of a constant current logic component of the constant current channel group of the display driving circuit 30; and the common anodes of the B primary color LEDs in the LED particles in a single column is interconnected to an input end of a constant current logic component of the constant current channel group of the display driving circuit 30.

In the second transformed mode, the power supply control circuit 351 in the display driving circuit 30 controls any one of the N-MOS transistors in the switching sub-circuit 31 to be in an turn-on state through the power supply control port to supply power to the anodes of the LED particles in a corresponding line on the LED display panel 10, and the driving control circuit 353 outputs a constant current control signal to each constant current logic component in the constant current channel group through the driving control port to control each constant current logic component to be in a turned on working state, thereby providing the current path for the anodes of the primary color LEDs of the LED particles in the corresponding columns and realizing the ordered display of the LED unit board. In the above, the anodes of the primary color LEDs of the LED particles in the corresponding columns include the anodes of three primary colors R, G and B, that is, the ordered display of the red lamp tubes, the green lamp tubes and the blue lamp tubes of the LED particles in the corresponding columns is also controlled respectively.

Based on the technical solution shown in the second transformed mode of embodiment 1, there can also be a transformed implementation mode as follows:

the field effect transistors can be N-MOS transistors, the LED display panel 10 can include M lines*N columns of LED particles, and each LED particle includes a red lamp tube, a green lamp tube and a blue lamp tube respectively, wherein the cathode of the red lamp tube, the cathode of the green lamp tube and the cathode of the blue lamp tube in each LED particle in each line are connected in parallel, and are connected with the drain of a corresponding N-MOS transistor in the switching circuit 31; the anode of the red lamp tube of each LED particle in each column is connected in parallel respectively, and is connected with a second end of a corresponding constant current logic component in the constant current channel group respectively; the anode of the green lamp tube of each LED particle in each column is connected in parallel respectively, and is connected with a second end of a corresponding constant current logic component in the constant current channel group respectively; and the anode of the blue lamp tube of each LED particle in each column is connected in parallel respectively, and is connected with a second end of a corresponding constant current logic component in the constant current channel group respectively.

Specifically, the cathodes of the LED particles in a single line in the LED display panel 10 in the implementation mode can also be interconnected to an output pin corresponding to the drain of one N-MOS transistor in the switching circuit 31 in the display driving circuit 30, and the anodes of the LEDs in the same primary color in the LED particles in a single column are interconnected to an input end(s) of a constant current logic component(s) of the constant current channel group of the display driving circuit 30, that is, the common anodes of the R primary color LEDs in the LED particles in a single column are interconnected to an input end of a constant current logic component of the constant current channel group of the display driving circuit 30; the common anodes of the G primary color LEDs in the LED particles in a single column are interconnected to an input end of a constant current logic component of the constant current channel group of the display driving circuit 30; and the common anodes of the B primary color LEDs in the LED particles in a single column are interconnected to an input end of a constant current logic component of the constant current channel group of the display driving circuit 30.

Based on the technical solution shown in embodiment 1, there can also be the third transformed implementation mode as follows:

in the implementation mode, the driving circuit 33 can include a first constant current channel group, a second constant current channel group and a third constant current channel group, wherein the first constant current channel group includes one or more constant current logic components, a first end of each constant current logic component is connected with the power end or grounding end of the power supply equipment respectively, a third end of each constant current logic component is connected with a first R display control sub-port of the driving control port respectively, and a second end of each constant current logic component is connected with the anode or cathode of the red lamp tube in each LED particle in a corresponding column in the LED display panel 10 respectively, for controlling the display of the red lamp tubes of the LED display panel 10; the second constant current channel group includes one or more constant current logic components, wherein a first end of each constant current logic component is connected with the power end or grounding end of the power supply equipment respectively, a third end of each constant current logic component is connected with a first G display control sub-port of the driving control port respectively, and a second end of each constant current logic component is connected with the anode or cathode of the green lamp tube in each LED particle in the corresponding column in the LED display panel 10 respectively, for controlling the display of the green lamp tubes of the LED display panel 10; and the third constant current channel group includes one or more constant current logic components, a first end of each constant current logic component is connected with the power end or grounding end of the power supply equipment respectively, a third end of each constant current logic component is connected with a first B display control sub-port of the driving control port respectively, and a second end of each constant current logic component is connected with the anode or cathode of the blue lamp tube in each LED particle in the corresponding column in the LED display panel 10 respectively, for controlling the display of the blue lamp tubes of the LED display panel 10. In the above, the first constant current channel group can be an R primary color constant current channel group, the second constant current channel group can be a G primary color constant current channel group, and the third constant current channel group can be a B primary color constant current channel group.

Specifically, the R primary color constant current channel group can include one or more constant current logic components, the second ends (i.e. input ends) of these constant current logic components are connected to the cathodes (i.e. R primary color cathodes) of the red lamp tubes of the LED particles in the corresponding columns in the LED display panel 10, the first ends (i.e. output ends) of the constant current logic components are interconnected as an external pin GND of the display driving circuit 30, and are connected to the grounding end of the power supply equipment, and the third ends (i.e. control ends) of the constant current logic components are connected to the first R display control sub-port of the driving control port to receive an R display control signal of the driving control circuit 353; the G primary color constant current channel group can include one or more constant current logic components, the second ends (i.e. input ends) of these constant current logic components are connected to the cathodes (i.e. G primary color cathodes) of the green lamp tubes of the LED particles in the corresponding columns in the LED display panel 10, the first ends (i.e. output ends) of the constant current logic components are interconnected as the external pin GND of the display driving circuit 30, and are connected to the grounding end of the power supply equipment, and the third ends (i.e. control ends) of the constant current logic components are connected to the first G display control sub-port of the driving control port to receive a G display control signal of the driving control circuit 353; and the B primary color constant current channel group can include one or more constant current logic components, the second ends (i.e. input ends) of these constant current logic components are connected to the cathodes (i.e. B primary color cathodes) of the blue lamp tubes of the LED particles in the corresponding columns in the LED display panel 10, the first ends (i.e. output ends) of the constant current logic components are interconnected as the external pin GND of the display driving circuit 30, and are connected to the grounding end of the power supply equipment, and the third ends (i.e. control ends) of the constant current logic components are connected to the first B display control sub-port of the driving control port to receive a B display control signal of the driving control circuit 353.

In the implementation mode, the power supply control circuit 351 controls each field effect transistor to be switched on to supply power to the LED particles in a line corresponding to the field effect transistor in the LED display panel 10; the driving control circuit 353 is configured to control each constant current logic component in the first constant current channel group to be turned on through the first R display control sub-port, and each constant current logic component provides a current path for the red lamp tubes in the LED particles in a column corresponding to the constant current logic component in the LED display panel 10 respectively after the each constant current logic component is turned on, so as to control the display of the red lamp tubes of the LED particles in a line corresponding to the field effect transistor in the LED display panel 10; the driving control circuit 353 is further configured to control each constant current logic component in the second constant current channel group to be turned on through the first G display control sub-port, and each constant current logic component provides a current path for the green lamp tubes in the LED particles in a column corresponding to the constant current logic component in the LED display panel 10 respectively after the each constant current logic component is turned on, so as to control the display of the green lamp tubes of the LED particles in a line corresponding to the field effect transistor in the LED display panel 10; and the driving control circuit 353 is further configured to control each constant current logic component in the third constant current channel group to be turned on through the first B display control sub-port, and each constant current logic component provides a current path for the blue lamp tubes in the LED particles in a column corresponding to the constant current logic component in the LED display panel 10 respectively after the each constant current logic component is turned on, so as to control the display of the blue lamp tubes of the LED particles in a line corresponding to the field effect transistor in the LED display panel 10.

In the implementation mode, the power supply control port of the display driving circuit 30 is unchanged, and the driving control port includes three control sub-ports for controlling the turning-on or cutting-off of the first/second/third constant current channel groups to enable the switching circuit and the driving circuit to respectively control the power supply of the LED particles in a single line and the ordered display of the LED particles in a single column in the LED display panel. In the transformed mode, the switching circuit 31, the driving circuit 33 and the control circuit 35 are integrated in the display driving circuit 30, and though the driving circuit includes the three constant current channel groups, more display driving circuits 30 can still be placed under the condition of not changing the area of the LED display panel 10, so that the number ratio of the LED particles and the display driving circuits 30 on the LED display with the fixed area is reduced, and the refreshing rate is increased; moreover, the connection relationship between the display driving circuits 30 and the LED particle array in the LED display panel 10 is clearer, fewer connection lines are required, and the design difficulty of the PCB is decreased.

In the implementation mode, the field effect transistors can be P-MOS transistors, the LED display panel 10 includes M lines*N columns of LED particles, and each LED particle includes a red lamp tube, a green lamp tube and a blue lamp tube respectively, wherein the anode of the red lamp tube, the anode of the green lamp tube and the anode of the blue lamp tube in the ith LED particle in each line are connected in parallel with the ith joint, and each joint in each line is connected in parallel, and is connected with the drain of a corresponding P-MOS transistor in the switching circuit 31; the cathode of the red lamp tube of each LED particle in each column is connected in parallel respectively, and is connected with a second end of a corresponding constant current logic component in the first constant current channel group respectively; the cathode of the green lamp tube of each LED particle in each column is connected in parallel respectively, and is connected with a second end of a corresponding constant current logic component in the second constant current channel group respectively; and the cathode of the blue lamp tube of each LED particle in each column is connected in parallel respectively, and is connected with a second end of a corresponding constant current logic component in the third constant current channel group respectively. In the above, 1≦i≦N, and i is a natural number, and the red lamp tube, the green lamp tube and the blue lamp tube can be the R/G/B primary color LEDs respectively.

In addition, the LED display panel 10 (which can also be called as an LED unit) includes a matrix with M lines*N columns of LED particles, wherein the anodes of the LED particles in a single line are interconnected to the ith joint, each joint is connected to an output pin corresponding to the drain of one P-MOS transistor in the switching circuit 31 in the display driving circuit 30, and the cathodes of the LEDs in the same primary color in the LED particles in a single column are interconnected to an input end(s) of a constant current logic component(s) of the first constant current channel group of the display driving circuit 30, that is, the common cathodes of the R primary color LEDs in the LED particles in a single column are interconnected to an input end of a constant current logic component of the second constant current channel group of the display driving circuit 30; the common cathodes of the G primary color LEDs in the LED particles in a single column are interconnected to an input end of a constant current logic component of the constant current channel group of the display driving circuit 30; and the common cathodes of the B primary color LEDs in the LED particles in a single column are interconnected to an input end of a constant current logic component of the third constant current channel group of the display driving circuit 30.

In the embodiment, the power supply control circuit 351 of the display driving circuit 30 controls any one of the P-MOS transistors in the switching sub-circuit to be in an turn-on state through the power supply control port to supply power to the anodes of the LED particles in a corresponding line on the LED display panel 10, and the driving control circuit 353 outputs an R display control signal/G display control signal/B display control signal to each constant current logic component in the first constant current channel group/second constant current channel group/third constant current channel group through the first R display control sub-port/first G display control sub-port/first B display control sub-port to control each constant current logic component in the three constant current channel groups to be in an turned on working state, thereby providing the current paths for the R primary color cathodes, G primary color cathodes and B primary color cathodes of the LED particles in the corresponding columns and realizing the ordered display of the LEDs. In the above, the R primary color cathodes, G primary color cathodes and B primary color cathodes of the LED particles in the corresponding columns are the cathodes of the red lamp tubes, the green lamp tubes and the blue lamp tubes of the LED particles in the corresponding columns respectively. In the above, the switching sub-circuit can also be called as a P-MOS channel.

Based on the technical solution shown in the third transformed implementation mode of embodiment 1, there can also be a transformed implementation mode as follows:

the field effect transistors can be P-MOS transistors, the LED display panel 10 can include M lines*N columns of LED particles, and each LED particle includes a red lamp tube, a green lamp tube and a blue lamp tube respectively, wherein the anode of the red lamp tube, the anode of the green lamp tube and the anode of the blue lamp tube in each LED particle in each line are connected in parallel, and are connected with the drain of a corresponding P-MOS transistor in the switching circuit 31 respectively; the cathode of the red lamp tube of each LED particle in each column is connected in parallel respectively, and is connected with a second end of a corresponding constant current logic component in the first constant current channel group respectively; the cathode of the green lamp tube of each LED particle in each column is connected in parallel respectively, and is connected with a second end of a corresponding constant current logic component in the second constant current channel group respectively; and the cathode of the blue lamp tube of each LED particle in each column is connected in parallel respectively, and is connected with a second end of a corresponding constant current logic component in the third constant current channel group respectively.

Specifically, the anodes of the LED particles in a single line in the LED display panel 10 are interconnected to an output pin corresponding to the drain of one P-MOS transistor in the switching circuit 31 in the display driving circuit 30, and the cathodes of the LEDs in the same primary color in the LED particles in a single column are interconnected to an input end(s) of a constant current logic component(s) of the first constant current channel group of the display driving circuit 30, that is, the common cathodes of the R primary color LEDs in the LED particles in a single column are interconnected to an input end of a constant current logic component of the second constant current channel group of the display driving circuit 30; the common cathodes of the G primary color LEDs in the LED particles in a single column are interconnected to an input end of a constant current logic component of the constant current channel group of the display driving circuit 30; and the common cathodes of the B primary color LEDs in the LED particles in a single column are interconnected to an input end of a constant current logic component of the third constant current channel group of the display driving circuit 30.

In the implementation mode, the control mode is the same as that of the display driving circuit 30 in the technical solution shown in the third transformed implementation mode of embodiment 1, and similarly, the power supply control circuit 351 controls a certain P-MOS transistor in the switching circuit 31 (i.e. the P-MOS channel group) to be in an turn-on state through the power supply control port to supply power to the anodes of the LED particles in a corresponding line on the LED display panel 10, and the driving control circuit 353 outputs the R display control signal/G display control signal/B display control signal to each constant current logic component in the first constant current channel group/second constant current channel group/third constant current channel group through the first R display control sub-port/first G display control sub-port/first B display control sub-port to control each constant current logic component in the three constant current channel groups to be in a turned on working state, thereby providing the current paths for the R primary color cathodes, G primary color cathodes and B primary color cathodes of the LED particles in the corresponding columns and realizing the ordered display of the LEDs. In the above, the R primary color cathodes, G primary color cathodes and B primary color cathodes of the LED particles in the corresponding columns are the cathodes of the red lamp tubes, the green lamp tubes and the blue lamp tubes of the LED particles in the corresponding columns respectively.

### Embodiment 2

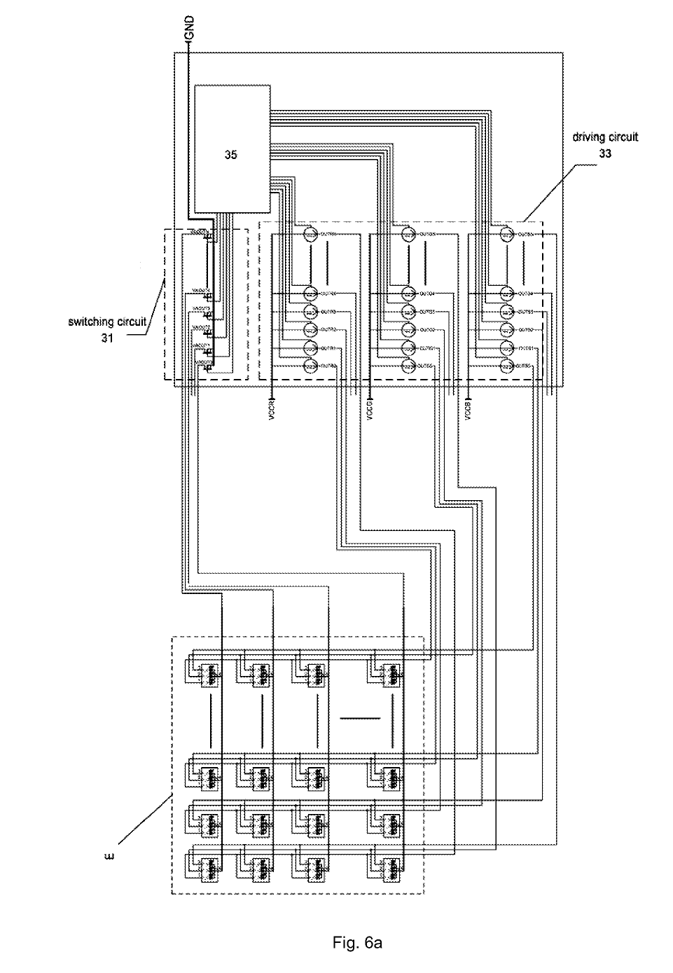

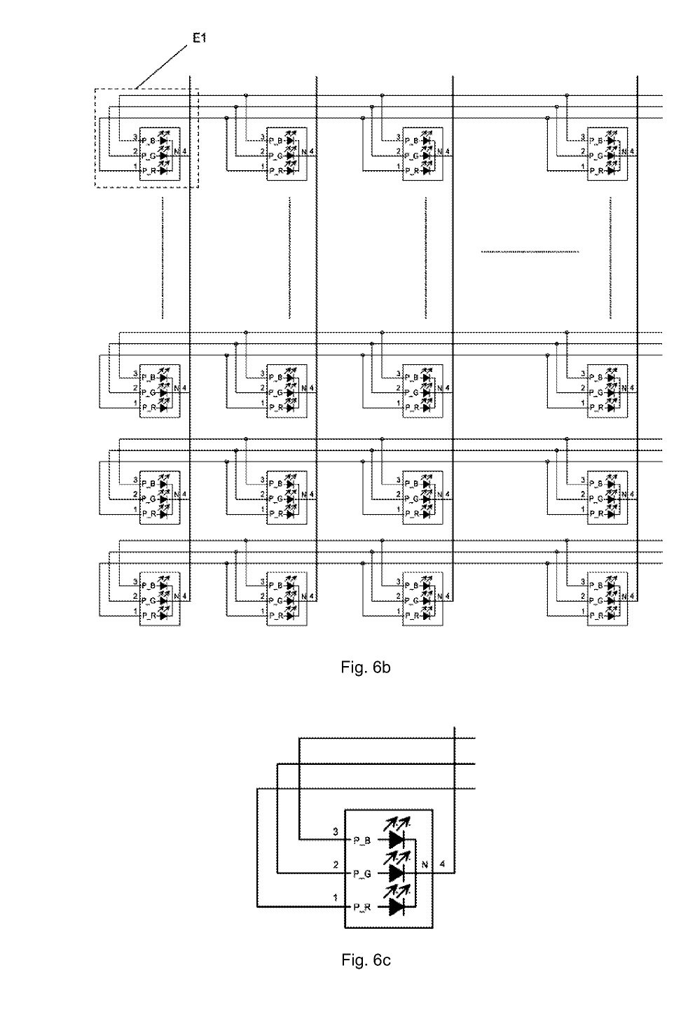

FIG. 6a to FIG. 6c are structure schematic diagrams of an LED display according to embodiment 2 of the invention. As shown in FIG. 6a, field effect transistors in the LED display can also be N-MOS transistors, an LED display panel 10 can include M lines*N columns of LED particles, and each of the LED particles includes a red lamp tube, a green lamp tube and a blue lamp tube respectively, wherein a cathode of the red lamp tube, a cathode of the green lamp tube and a cathode of the blue lamp tube in the ith LED particle in each line are connected in parallel with the ith joint, and each joint in each line is connected in parallel, and is connected with a drain of a corresponding N-MOS transistor in the switching circuit 31 respectively; an anode of the red lamp tube in each LED particle in each column is connected in parallel respectively, and is connected with a second end of a corresponding constant current logic component in the first constant current channel group as a connection terminal of an anode of the LED display panel 10; an anode of the green lamp tube of each LED particle in each column is connected in parallel respectively, and is connected with the second end of a corresponding constant current logic component in a second constant current channel group as a connection terminal of an anode of the LED display panel 10; and an anode of the blue lamp tube of each LED particle in each column is connected in parallel respectively, and is connected with a second end of a corresponding constant current logic component in the third constant current channel group as a connection terminal of an anode of the LED display panel 10.

Specifically, as shown in FIG. 6a, a R primary color constant current channel group can include one or more constant current logic components, first ends (input ends in the embodiment) of these constant current logic components are interconnected as an external pin VCCR of the display driving circuit 30, and are connected to a grounding end of power supply equipment, second ends (i.e. output ends) of the constant current logic components are connected to the anodes (R primary color anodes in the embodiment) of the red lamp tubes of the LED particles in the corresponding columns in the LED display panel 10, and third ends (i.e. control ends) of the constant current logic components are connected to a first R display control port; a G primary color constant current channel group can include one or more constant current logic components, first ends (input ends in the embodiment) of these constant current logic components are interconnected as an external pin VCCG of the display driving circuit 30, and are connected to a power end of the power supply equipment, second ends (i.e. output ends) of the constant current logic components are connected to the anodes (G primary color anodes in the embodiment) of the green lamp tubes of the LED particles in the corresponding column in the LED display panel 10, and third ends (i.e. control ends) of the constant current logic components are connected to a first G display control port; and a B primary color constant current channel group can include one or more constant current logic components, first ends (input ends in the embodiment) of the constant current logic components are interconnected, as an external pin VCCB of the display driving circuit 30, and are connected to the power end of the power supply equipment, second ends (i.e. output ends) of the constant current logic components are connected to the anodes (B primary color anodes in the embodiment) of the blue lamp tubes of the LED particles in the corresponding columns in the LED display panel 10, and third ends (i.e. control ends) of the constant current logic components are connected to a first B display control port.

The LED particle shown in FIG. 6c is a partial enlarged drawing of a part E1 covered by a dashed line in FIG. 6b, wherein pin 4 is a common cathode, and pins 2/3/4 are the anodes of B/G/R LEDs.

In the above, in the embodiment, a power supply voltage of the external pin VCCR of the display driving circuit 30 can be lower than that of the external pin VCCR/VCCB, and specifically, the power supply voltage of the VCCR can be 1.6V which is obtained by subtracting a working voltage (1.8-2V) of the red lamp tubes from a working voltages (3.4-3.6V) of the green or blue lamp tubes, and the power supply voltages of the R/G/B primary color LEDs are differentially controlled, thereby reducing the power consumption of the LED display.

In embodiment 2, the LED display panel 10 (which can also be called as an LED unit as well as an LED unit board) includes a matrix with M lines*N columns of LED particles, wherein the cathodes of the LED particles in a single line are interconnected to the ith joint, each joint is connected to an output pin corresponding to a drain of one N-MOS transistor in the switching circuit 31 in the display driving circuit 30, and the anodes of the LEDs in the same primary color in the LED particles in a single column are interconnected to an input end(s) of a corresponding constant current logic component(s) of the first constant current channel group of the display driving circuit 30, that is, the common anodes of the R primary color LEDs in the LED particles in a single column are interconnected to an input end of a constant current logic component of the second constant current channel group of the display driving circuit 30; the common anodes of the G primary color LEDs in the LED particles in a single column are interconnected to an input end of a constant current logic component of the constant current channel group of the display driving circuit 30; and the common anodes of the B primary color LEDs in the LED particles in a single column are interconnected to an input end of a constant current logic component of the third constant current channel group of the display driving circuit 30. Under the control of the display driving circuit 30, the power supply control circuit 351 controls a certain N-MOS transistor in the switching sub-circuit 31(which can be an N-MOS channel group) to be in an turn-on state through a power supply control port to supply power to the anodes of the LED particles in a corresponding line on the LED display panel 10, and the driving control circuit 353 outputs an R display control signal/G display control signal/B display control signal to each constant current logic component in the first constant current channel group/second constant current channel group/third constant current channel group through the first R display control sub-port/first G display control sub-port/first B display control sub-port to control each constant current logic component in the three constant current channel groups to be in a turned on working state, thereby providing the current paths for the R primary color anodes, G primary color anodes and B primary color anodes of the LED particles in the corresponding columns and realizing the ordered display of the LEDs. In the above, the R primary color anodes, G primary color anodes and B primary color anodes of the LED particles in the corresponding columns are the anodes of the red lamp tubes, the green lamp tubes and the blue lamp tubes of the LED particles in the corresponding columns respectively.

### Embodiments 3 and 4

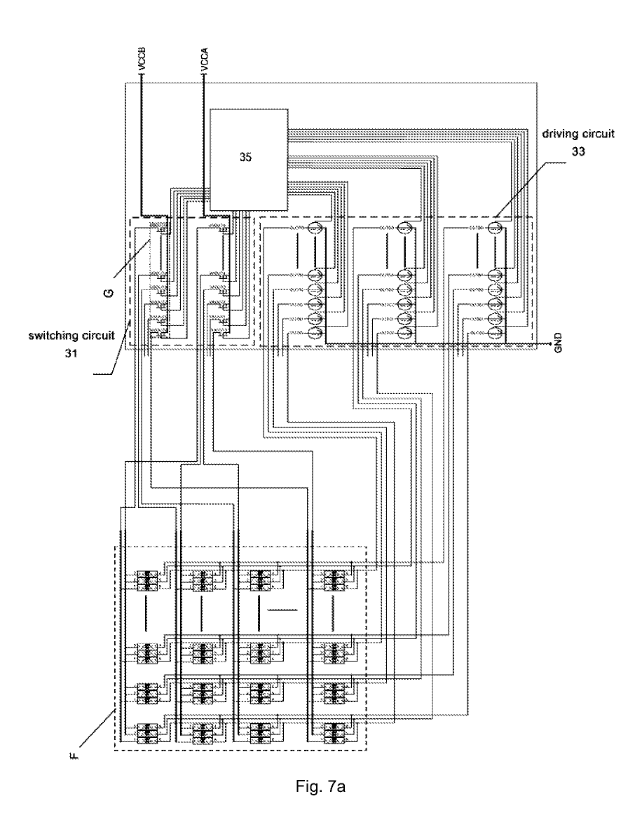

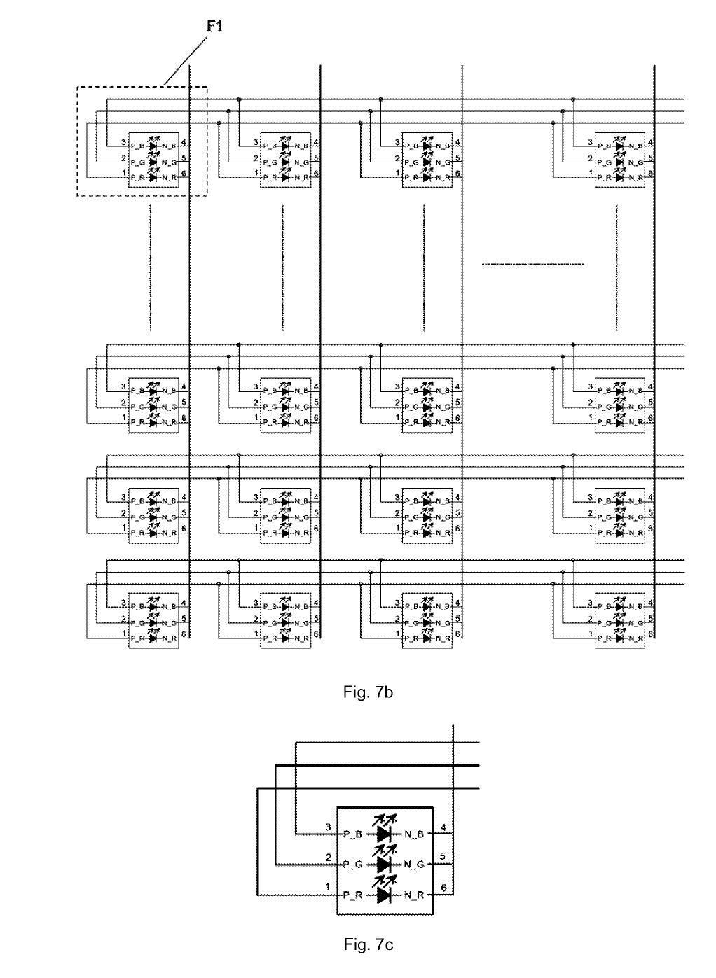

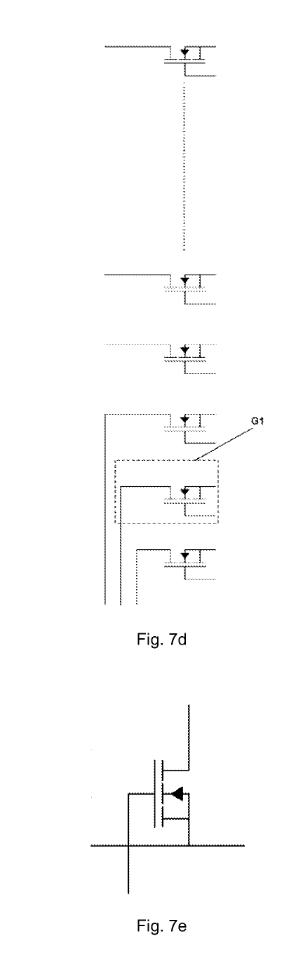

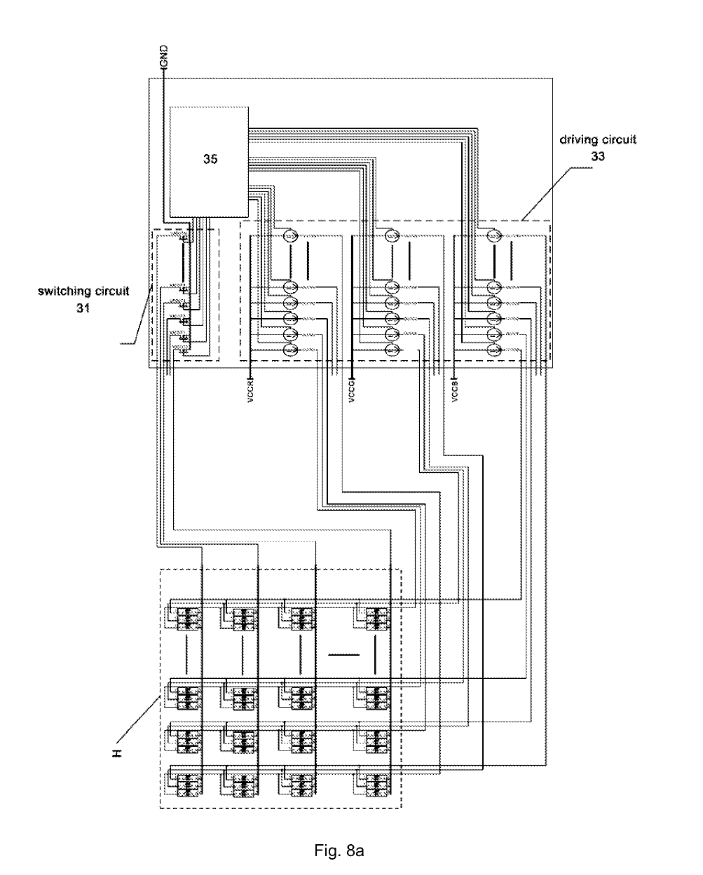

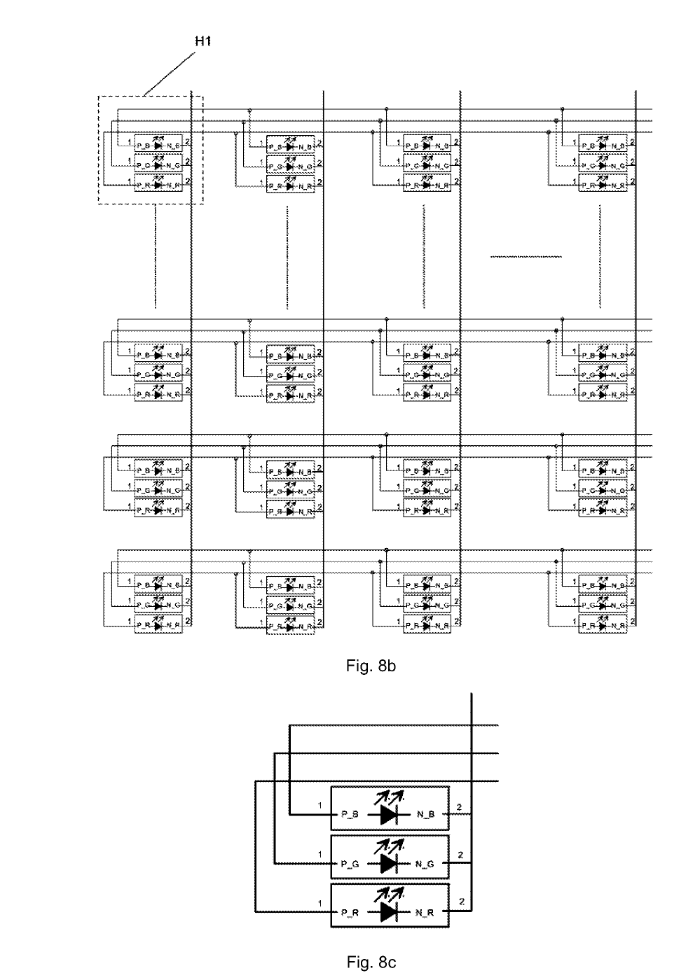

FIG. 7a to FIG. 7e are structure schematic diagrams of an LED display according to embodiment 3 of the invention; and FIG. 8a to FIG. 8c are structure schematic diagrams of an LED display according to embodiment 4 of the invention. FIG. 7b and FIG. 8b show partial enlarged drawings of a part F covered by a dashed line in FIG. 7a and a part H covered by a dashed line in FIG. 8a in the two embodiments respectively, LEDs of three primary colors in an LED particle in FIG. 7c are directly integrated on the LED particle, LEDs in three primary colors in an LED particle in FIG. 8c are encapsulated and integrated on the LED particle respectively, but beyond that, the same circuit connection relationship can be adopted in the two implementation modes. In the above, an anode of each LED particle in FIG. 7c has three pins, i.e. 1, 2 and 3 respectively, corresponding to anodes of internal R/G/B primary color LEDs respectively, and a cathode of each LED particle in FIG. 7c has three pins, i.e. 4, 5 and 6 respectively, corresponding to cathodes of the internal B/G/R primary color LEDs respectively; and as shown in FIG. 8c, the anodes of the R/G/B primary color LEDs are pins 1, the cathodes of the R/G/B primary color LEDs are pins 2, and the R/G/B primary color LEDs are welded in parallel as the LED particles (i.e. full-color pixels).

Specifically, as shown in FIG. 7e and FIG. 8a, field effect transistors can also be N-MOS transistors, an LED display panel 10 can include M lines*N columns of LED particles, and each LED particle includes a red lamp tube, a green lamp tube and a blue lamp tube respectively, wherein the cathode of the red lamp tube, the cathode of the green lamp tube and the cathode of the blue lamp tube in each LED particle in each line are connected in parallel, and are connected with a drain of a corresponding N-MOS transistor in a switching circuit 31 respectively; the anode of the red lamp tube in each LED particle in each column is connected in parallel respectively, and is connected with a second end of a corresponding constant current logic component in the first constant current channel group; the anode of the green lamp tube of each LED particle in each column is connected in parallel respectively, and is connected with a second end of a corresponding constant current logic component in the second constant current channel group respectively; and the anode of the blue lamp tube of each LED particle in each column is connected in parallel respectively, and is connected with the second end of a corresponding constant current logic component in the third constant current channel group respectively.

In embodiments 3 and 4, the anodes of the LED particles in a single line in the LED display panel 10 are interconnected to an output pin corresponding to a drain of one N-MOS transistor in the switching circuit 31 in the display driving circuit 30, the cathodes of the LED particles in a single line are interconnected to the ith joint, each joint is connected to an output pin corresponding to a drain of one N-MOS transistor in the switching circuit 31 in the display driving circuit 30, and the anodes of the LEDs in the same primary color in the LED particles in a single column are interconnected to an input end(s) of a corresponding constant current logic component(s) of the first constant current channel group of the display driving circuit 30, that is, the common anodes of the R primary color LEDs in the LED particles in a single column are interconnected to an input end of a constant current logic component of the second constant current channel group of the display driving circuit 30; the common anodes of the G primary color LEDs in the LED particles in a single column are interconnected to an input end of a constant current logic component of the constant current channel group of the display driving circuit 30; and the common anodes of the B primary color LEDs in the LED particles in a single column are interconnected to an input end of a constant current logic component of the third constant current channel group of the display driving circuit 30.

Based on the technical solutions shown in embodiments 3 and 4, there can also be the first transformed implementation mode as follows:

in the implementation mode, the switching circuit 31 includes a first switching sub-circuit and a second switching sub-circuit, each of the first switching sub-circuit and the second switching sub-circuit includes one or more field effect transistors respectively, and a source of each of the field effect transistors in the first switching sub-circuit and the second switching sub-circuit is connected with a power end or grounding end of power supply equipment respectively, wherein a drain of each field effect transistor in the first switching sub-circuit is connected with an anode or cathode of a red lamp tube in each LED particle in a corresponding line in the LED display panel respectively, and a gate of each field effect transistor is connected with a corresponding connection terminal in a power supply control port respectively, for controlling the power supply of the red lamp tubes of the LED display panel; and a drain of each field effect transistor in the second switching sub-circuit is connected with the anodes or cathodes of a green lamp tube and a blue lamp tube in each LED particle in a corresponding line in the LED display panel respectively, and a gate of each field effect transistor is connected with a corresponding connection terminal in the power supply control port respectively, for controlling the power supply of the green lamp tubes and the blue lamp tubes of the LED display panel.

In the implementation mode, the driving circuit 33 can include a constant current channel group, and the constant current channel group can include: one or more constant current logic components, wherein a first end of each constant current logic component is connected with a power end or grounding end of the power supply equipment respectively; a second end of each constant current logic component is connected with the anodes or cathodes of the LED particles in a corresponding column in the LED display panel 10 respectively; and a third end of each constant current logic component is connected with a corresponding connection terminal in the driving control port respectively.

In addition, in the embodiment, the power supply control circuit 351 is configured to control one field effect transistor in the first switching sub-circuit to be switched on to supply power to the red lamp tubes in the LED particles in the line corresponding to the field effect transistor in the first switching sub-circuit in the LED display panel 10; the power supply control circuit 351 is further configured to control one field effect transistor, which corresponds to the field effect transistor in the first switching sub-circuit, in the second switching sub-circuit to be switched on to supply power to the green lamp tubes and the blue lamp tubes in the LED particles in the line, which corresponds to the field effect transistor in the first switching sub-circuit, in the LED display panel 10; and the driving control circuit 353 is configured to control each constant current logic component in the constant current channel group to be turned on and each constant current logic component provides a current path for the LED particles in a column corresponding to the constant current logic component in the LED display panel 10 respectively after the each constant current logic component is turned on, so as to control the ordered display of the LED particles in a line corresponding to the field effect transistor in the LED display panel 10.

The switching circuit 31, the driving circuit 33 and the control circuit 35 are integrated in the display driving circuit 30, and then more display driving circuits 30 can be placed under the condition of not changing the area of the LED display panel 10, so that the number ratio of the LED particles and the display driving circuits 30 on the LED display with the fixed area is reduced, and the refreshing rate is increased.

The field effect transistors of the display driving circuit 30 in the embodiment can be P-MOS transistors, the LED display panel 10 can include M lines*N columns of LED particles, and each LED particle includes a red lamp tube, a green lamp tube and a blue lamp tube respectively, wherein the anode of the red lamp tube in the ith LED particle in each line is connected in parallel with the ith joint, and each joint in each line is connected in parallel, and is connected with a drain of a corresponding P-MOS transistor in the first switching sub-circuit 31 respectively; the anodes of the green lamp tube and the blue lamp tube in the jth LED particle in each line are connected in parallel with the jth joint, and each joint in each line is connected in parallel, and is connected to a drain of a corresponding P-MOS transistor in the second switching sub-circuit 31; the cathode of the red lamp tube of each LED particle in each column is connected in parallel respectively, and is connected with a second end of a corresponding constant current logic component in the constant current channel group respectively; the cathode of the green lamp tube of each LED particle in each column is connected in parallel respectively, and is connected with a second end of a corresponding constant current logic component in the constant current channel group respectively; and the cathode of the blue lamp tube of each LED particle in each column is connected in parallel respectively, and is connected with a second end of a corresponding constant current logic component in the constant current channel group respectively. In the above, 1≦i≦N, 1≦j≦N both i and j are natural numbers, and the red lamp tubes, the green lamp tubes and the blue lamp tubes can be R/G/B primary color LEDs.

In the implementation mode, the display driving circuit 30 integrates the first switching sub-circuit and the second switching sub-circuit, and each of the two switching sub-circuits includes one or more P-MOS transistors respectively; a source of each P-MOS transistor of the first switching sub-circuit is interconnected as an external pin VCCB of the display driving circuit 30, and is connected to a connection terminal of a power end of a power supply equipment, a gate of each P-MOS transistor is connected to an R power supply control signal of the power supply control port, and a drain of each P-MOS transistor is connected to the anodes (i.e. R primary color anodes of the LED particles in a corresponding line) of the red lamp tubes of the LED particles in a corresponding line in the LED display panel 10; and a source of each P-MOS transistor of the second switching sub-circuit is interconnected as an external pin VCCA of the display driving circuit 30, and is connected to a connection terminal of a power end of a power supply equipment, a gate of each P-MOS transistor is connected to green and blue power supply control signals of the power supply control port, and a drain of each P-MOS transistor is connected to the anodes (i.e. G primary color anodes and B primary color anodes of the LED particles in a corresponding line) of the green lamp tubes and the blue lamp tubes of the LED particles in a corresponding line in the LED display panel 10.

The driving circuit 33 can be the same as that shown in embodiment 1, and can include a constant current channel group, wherein the constant current channel group includes multiple constant current logic components (which can also be called as constant current logic circuits); and a second end (i.e. input end) of each constant current logic component serves as one of input pins of the display driving circuit 30 respectively, first ends (i.e. output ends) of all the constant current logic components are internally interconnected, and are connected to the grounding end (i.e. GND end) of the display driving circuit 30, and third ends (i.e. control ends) of the constant current logic components are connected with the driving control port of the control circuit 35, for receiving a constant current control signal of the driving circuit 33.

In the implementation mode, the anode of the red lamp tube in the ith LED particle in each line in the LED display panel 10 is connected in parallel with the ith joint, and each joint in each line is connected in parallel, and is connected with a drain of a corresponding P-MOS transistor in the first switching sub-circuit 31 respectively; the anodes of the green lamp tube and the blue lamp tube in the jth LED particle in each line are connected in parallel with the jth joint, and each joint in each line is connected in parallel, and is connected to a drain of a corresponding P-MOS transistor in the second switching sub-circuit 31; the cathodes of the LEDs in the same primary color in each LED particle in a single column are interconnected to an input end(s) of a constant current logic component(s) in the constant current channel group of the display driving circuit 30, that is, the common cathodes of the red lamp tubes (i.e. R primary color display units) in the LED particles in a single column are interconnected to an input end of a constant current logic component of the constant current channel group of the display driving circuit 30; the common cathodes of the green lamp tubes (i.e. G primary color display units) in the LED particles in a single column are interconnected to an input end of a constant current logic component of the constant current channel group of the display driving circuit 30; and the common cathodes of the blue lamp tubes (i.e. B primary color display units) in the LED particles in a single column are interconnected to an input end of a constant current logic component of the constant current channel group of the display driving circuit 30.

In the implementation mode, power supply voltages between the first switching sub-circuit and the second switching sub-circuit can be different, a power supply voltage of VCCB is preferably 1.6V, and can be lower than that of the pin VCCA, and 1.6V is obtained by subtracting a typical working voltage (1.8-2V) of the red lamp tubes from the typical working voltages (3.4-3.6V) of the green or blue lamp tubes, so that the power supply voltages of the R/G/B primary color LEDs are differentially controlled to further reduce the power consumption of the LED display.

In the implementation mode, the power supply control circuit 351 of the display driving circuit 30 controls the corresponding P-MOS transistors in the corresponding same lines in the first switching sub-circuit and the second switching sub-circuit to be in an turn-on state through the power supply control port respectively to supply power to the anodes of the R primary color LEDs and the G/B primary color LEDs of the LED particles in the corresponding lines on the LED display panel 10 respectively, and the driving control circuit 353 outputs an R display control signal/G display control signal/B display control signal to each constant current logic component in the first constant current channel group/second constant current channel group/third constant current channel group through the first R display control sub-port/first G display control sub-port/first B display control sub-port to respectively control each constant current logic component in the three constant current channel groups to be in an turned on working state, thereby providing the current paths for the R primary color cathodes, G primary color cathodes and B primary color cathodes of the LED particles in the corresponding columns and realizing the ordered display of the LED particles.

Based on the technical solution shown in the first transformed implementation mode of embodiments 3 or 4, there can also be a transformed mode as follows:

the LED display panel 10 can also be implemented by an implementation mode as follows: the field effect transistors can be P-MOS transistors, the LED display panel 10 can include M lines*N columns of LED particles, and each LED particle includes a red lamp tube, a green lamp tube and a blue lamp tube respectively, wherein a cathode of a red lamp tube in each LED particle in each line is connected in parallel, and is connected with a drain of a corresponding P-MOS transistor in the first switching sub-circuit respectively; the anodes of a green lamp tube and a blue lamp tube in each LED particle in each line are connected in parallel, and are connected with a drain of a corresponding P-MOS transistor in the second switching sub-circuit respectively; a cathode of a red lamp tube of each LED particle in each column is connected in parallel respectively, and is connected with a second end of a corresponding constant current logic component in the constant current channel group respectively; a cathode of a green lamp tube of each LED particle in each column is connected in parallel respectively, and is connected with a second end of a corresponding constant current logic component in the constant current channel group respectively; and a cathode of a blue lamp tube of each LED particle in each column is connected in parallel respectively, and is connected with a second end of a corresponding constant current logic component in the constant current channel group respectively.

Specifically, an anode of a red lamp tube in each LED particle in each line in the LED display panel 10 is connected in parallel with a drain of a corresponding P-MOS transistor in the first switching sub-circuit; the anodes of a green lamp tube and a blue lamp tube in each LED particle in each line are connected in parallel with a drain of a corresponding P-MOS transistor in the second switching sub-circuit; the cathodes of the LEDs in the same primary color in the LED particles in a single column are interconnected to an input end(s) of a constant current logic component(s) of the constant current channel group, that is, the common cathodes of the R primary color LEDs in the LED particles in a single column are interconnected to an input end of a constant current logic component of the constant current channel group of the display driving circuit 30; the common cathodes of the G primary color LEDs in the LED particles in a single column are interconnected to an input end of a constant current logic component of the constant current channel group of the display driving circuit 30; and the common cathodes of the B primary color LEDs in the LED particles in a single column are interconnected to an input end of a constant current logic component of the constant current channel group of the display driving circuit 30.

Based on the technical solution shown in the first transformed implementation mode of embodiments 3 or 4, there can also be two transformed implementation modes as follows:

first: the field effect transistors can also be N-MOS transistors, the LED display panel 10 includes M lines*N columns of LED particles, and each LED particle includes a red lamp tube, a green lamp tube and a blue lamp tube, wherein the cathode of the red lamp tube in each LED particle in each line is connected in parallel, and is connected with a drain of a corresponding N-MOS transistor in the first switching sub-circuit respectively; the cathodes of the green lamp tube and the blue lamp tube in each LED particle in each line are connected in parallel, and are connected with a drain of a corresponding N-MOS transistor in the second switching sub-circuit respectively; an anode of a red lamp tube of each LED particle in each column is connected in parallel respectively, and is connected with a second end of a corresponding constant current logic component in the constant current channel group respectively; an anode of a green lamp tube of each LED particle in each column is connected in parallel respectively, and is connected with a second end of a corresponding constant current logic component in the constant current channel group respectively; and an anode of a blue lamp tube of each LED particle in each column is connected in parallel respectively, and is connected with a second end of a corresponding constant current logic component in the constant current channel group respectively.

Second: the field effect transistors are N-MOS transistors, the LED display panel 10 includes M lines*N columns of LED particles, and each LED particle includes a red lamp tube, a green lamp tube and a blue lamp tube respectively, wherein the cathode of the red lamp tube in the ith LED particle in each line is connected in parallel with the ith joint, and each joint in each line is connected in parallel, and is connected with a drain of a corresponding N-MOS transistor in the first switching sub-circuit 31 respectively; the cathodes of the green lamp tube and the blue lamp tube in the jth LED particle in each line are connected in parallel with the jth joint, and each joint in each line is connected in parallel, and is connected to a drain of a corresponding N-MOS transistor in the second switching sub-circuit 31; an anode of a red lamp tube of each LED particle in each column is connected in parallel respectively, and is connected with a second end of a corresponding constant current logic component in the constant current channel group respectively; an anode of a green lamp tube of each LED particle in each column is connected in parallel respectively, and is connected with a second end of a corresponding constant current logic component in the constant current channel group respectively; and an anode of a blue lamp tube of each LED particle in each column is connected in parallel respectively, and is connected with a second end of a corresponding constant current logic component in the constant current channel group respectively.

In the embodiment, the display driving circuit 30 integrates the first switching sub-circuit and the second switching sub-circuit, each of the two switching sub-circuits includes one or more N-MOS transistors respectively, a source of each N-MOS transistor of the first switching sub-circuit is interconnected, and can serve as an external pin GND of the display driving circuit 30, and is connected to a connection terminal of the power end of the power supply equipment, a gate of each N-MOS transistor is connected to an R power supply control signal of the power supply control port, and a drain of each N-MOS transistor is connected to the anodes (i.e. R primary color anodes of the LED particles in a corresponding line) of the red lamp tubes of the LED particles in a corresponding line in the LED display panel 10; and a source of each N-MOS transistor of the second switching sub-circuit is interconnected, and can serve as an external pin GND of the display driving circuit 30, and is connected to a connection terminal of the power end of the power supply equipment, a gate of each N-MOS transistor is connected to green and blue power supply control signals of the power supply control port, and a drain of each N-MOS transistor is connected to the anodes (i.e. G primary color anodes and B primary color anodes of the LED particles in a corresponding line) of the green lamp tubes and blue lamp tubes of the LED particles in a corresponding line in the LED display panel 10.

The driving circuit 33 can be the same as that shown in embodiment 1, and can include a constant current channel group, wherein the constant current channel group includes multiple constant current logic components (which can also be called as constant current logic circuits); and a second end (i.e. input end) of each constant current logic component serves as one of input pins of the display driving circuit 30 respectively, first ends (i.e. output ends) of all the constant current logic components are internally interconnected, as a VCC end of display driving circuits 30, and are connected to the power end of power supply equipment, and third ends (i.e. control ends) of the constant current logic components are connected with the driving control port of the control circuit 35, for receiving a constant current control signal of the driving circuit 33.

Specifically, in the first implementation mode of the transformed mode, the cathode of the red lamp tube in the ith LED particle in each line is connected in parallel with the ith joint, and each joint in each line is connected in parallel, and is connected with a drain of a corresponding N-MOS transistor in the first switching sub-circuit respectively; the cathodes of the green lamp tube and the blue lamp tube in the jth LED particle in each line are connected in parallel with the jth joint, and each joint in each line is connected in parallel, and is connected with a drain of a corresponding N-MOS transistor in the second switching sub-circuit; the common anodes of the R primary color LEDs in the LED particles in a single column are interconnected to an input end of a constant current logic component of the constant current channel group; the common anodes of the G primary color LEDs in the LED particles in a single column are interconnected to an input end of a constant current logic component of the constant current channel group; and the common anodes of the B primary color LEDs in the LED particles in a single column are interconnected to an input end of a constant current logic component of the constant current channel group.

In the second implementation mode, a cathode of a red lamp tube in each LED particle in each line is internally interconnected, and is connected with a drain of a corresponding N-MOS transistor in the first switching sub-circuit respectively, and the cathodes of a green lamp tube and a blue lamp tube in each LED particle in each line are interconnected, and are connected with a drain of a corresponding N-MOS transistor in the second switching sub-circuit respectively; the common anodes of the R primary color LEDs in the LED particles in a single column are interconnected, and is connected to an input end of a constant current logic component of the constant current channel group of the display driving circuit 30; the common anodes of the G primary color LEDs in the LED particles in a single column are interconnected, and is connected to an input end of a constant current logic component of the constant current channel group; and the common anodes of the B primary color LEDs in the LED particles in a single column are interconnected, and is connected to an input end of a constant current logic component of the constant current channel group.

### Embodiments 5 and 6

Specifically, the switching circuit 31 of the display driving circuit 30 includes a first switching sub-circuit and a second switching sub-circuit, and the driving circuit 33 includes a first constant current channel group, a second constant current channel group and a third constant current channel group, wherein structures of the first switching sub-circuit and the second switching sub-circuit can be the same as those in the first implementation mode in embodiment 1; the first constant current channel group can include one or more constant current logic components, wherein a first end of each constant current logic component is connected with a power end or grounding end of a power supply equipment respectively, a third end of each constant current logic component is connected with the first R display control sub-port of the driving control port respectively, and a second end of each constant current logic component is connected with an anode or cathode of a red lamp tube in each LED particle in the corresponding column in the LED display panel 10 respectively, for controlling the display of the red lamp tubes of the LED display panel 10; the second constant current channel group includes one or more constant current logic components, wherein a first end of each constant current logic component is connected with the power end or grounding end of the power supply equipment respectively, a third end of each constant current logic component is connected with the first G display control sub-port of the driving control port respectively, and a second end of each constant current logic component is connected with an anode or cathode of a green lamp tube in each LED particle in the corresponding column in the LED display panel 10 respectively, for controlling the display of the green lamp tubes of the LED display panel 10; and the third constant current channel group includes one or more constant current logic components, wherein a first end of each constant current logic component is connected with the power end or grounding end of the power supply equipment respectively, a third end of each constant current logic component is connected with the first B display control sub-port of the driving control port respectively, and a second end of each constant current logic component is connected with an anode or cathode of a blue lamp tube in each LED particle in the corresponding column in the LED display panel 10 respectively, for controlling the display of the blue lamp tubes of the LED display panel 10. In the above, the first constant current channel group can be an R primary color constant current channel group, the second constant current channel group can be a G primary color constant current channel group, and the third constant current channel group can be a B primary color constant current channel group.

Specifically, a power supply control circuit 351 in the control circuit 35 is configured to control one field effect transistor in the first switching sub-circuit to be switched on to supply power to the red lamp tubes in the LED particles in the line, which corresponds to the one of the field effect transistors in the first switching sub-circuit, in the LED display panel 10; the power supply control circuit 351 is further configured to control the field effect transistors corresponding to each field effect transistor in the first switching sub-circuit and in the second switching sub-circuit to be switched on to supply power to the green lamp tubes and the blue lamp tubes in the LED particles in a line corresponding to the field effect transistor in the first switching sub-circuit in the LED display panel 10; the driving control circuit 353 is configured to control each constant current logic component in the first constant current channel group to be turned on through the first R display control sub-port, and each constant current logic component provides a current path for the red lamp tubes in the LED particles in the column corresponding to the constant current logic component in the LED display panel 10 respectively after the each constant current logic component is turned on, so as to control the display of the red lamp tubes of the LED particles in the line corresponding to the field effect transistor in the LED display panel 10; the driving control circuit 353 is further configured to control each constant current logic component in the second constant current channel group to be turned on through the first G display control sub-port, and each constant current logic component provides a current path for the green lamp tubes in the LED particles in the column corresponding to the constant current logic component in the LED display panel 10 respectively after the each constant current logic component is turned on, so as to control the display of the green lamp tubes of the LED particles in the line corresponding to the field effect transistor in the LED display panel 10; and the driving control circuit 353 is further configured to control each constant current logic component in the third constant current channel group to be turned on through the first B display control sub-port, and each constant current logic component provides a current path for the blue lamp tubes in the LED particles in the column corresponding to the constant current logic component in the LED display panel 10 respectively after the each constant current logic component is turned on, so as to control the display of the blue lamp tubes of the LED particles in the line corresponding to the field effect transistor in the LED display panel 10.

In the above, the three constant current channel groups in the embodiment control the constant current display of the red lamp tubes, the green lamp tubes and the blue lamp tubes (which can be R/G/B three primary colors LEDs) on the LED display panel 10 respectively, the first switching sub-circuit and the second switching sub-circuit (each of the two switching sub-circuits can be a group of channels consisting of P-MOS transistors respectively, called P-MOS channels for short) in the switching circuit 31 are configured to control the power supply of the R/G/B three primary colors LEDs on the LED display panel 10 respectively, and the power supply control circuit 351 and the driving control circuit 353 in the display driving circuit 30 control working states of the switching circuit 31 and the driving circuit 33 respectively.

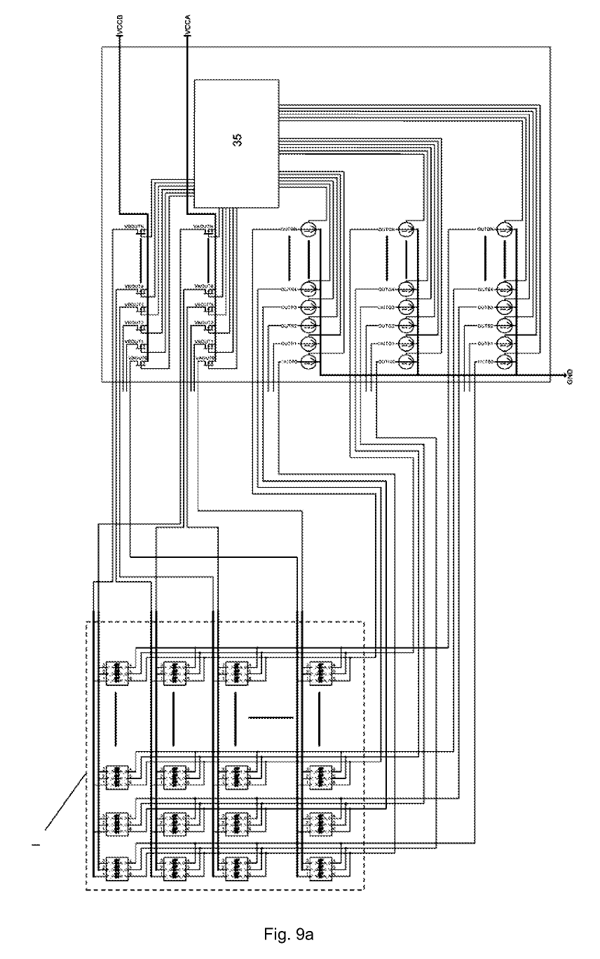

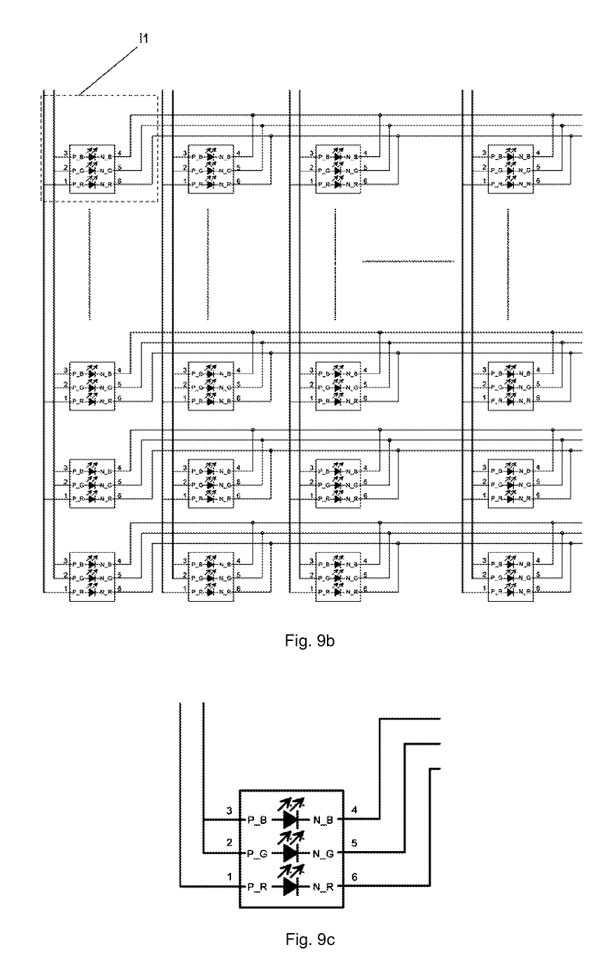

Correspondingly, the power supply control port includes a first power supply control port and a second power supply control port, wherein the first power supply control port is configured to transmit a first power supply control signal to the first switching sub-circuit (i.e. P-MOS channel group powered by VCCB shown in FIG. 9a), and the second power supply control port is configured to transmit a second power supply control signal to the second switching sub-circuit (i.e. P-MOS channel group powered by VCCA); and the driving control port includes a second R/G/B display control sub-port which transmits a second R/G/B display control signal to the R/G/B constant current channel group respectively.

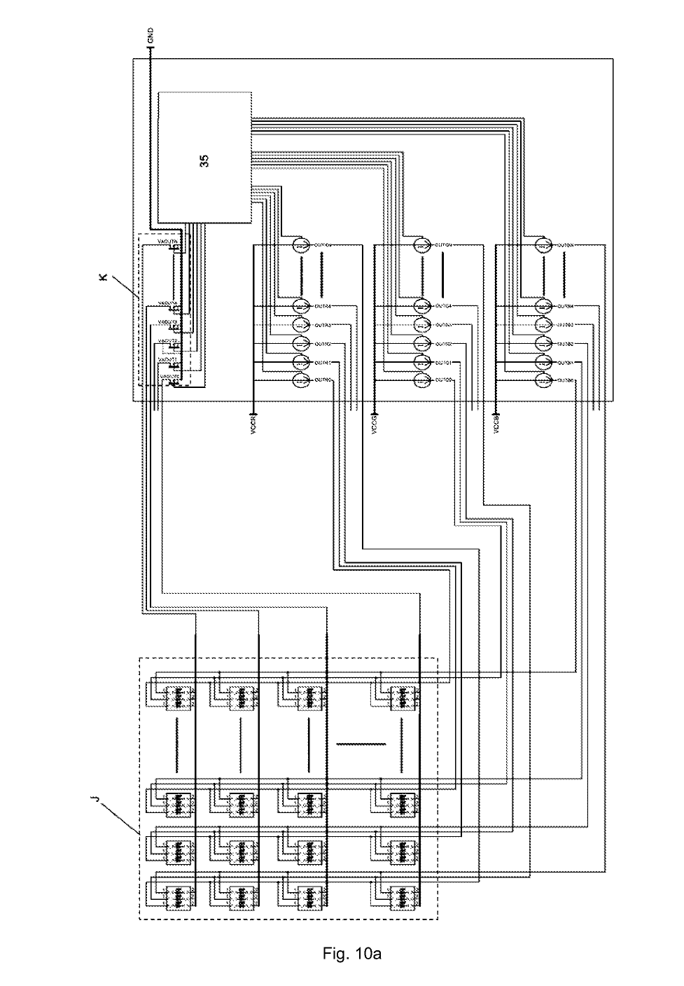

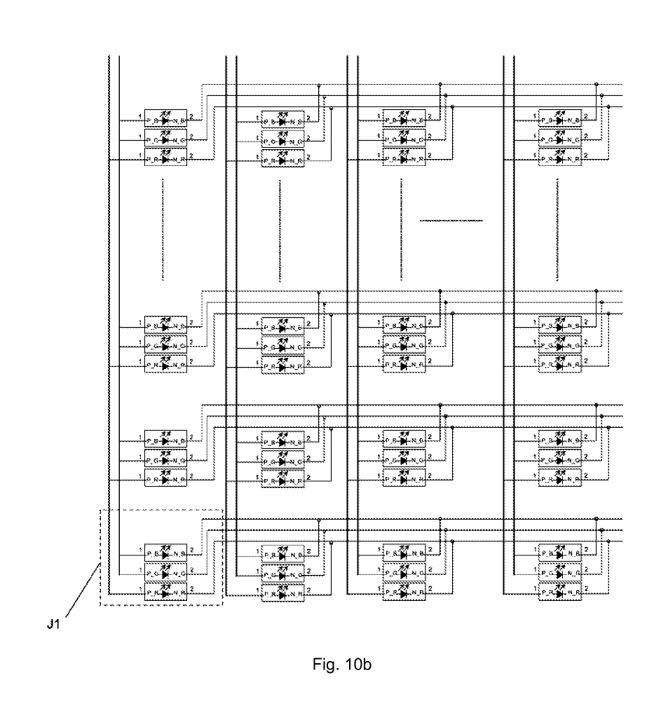

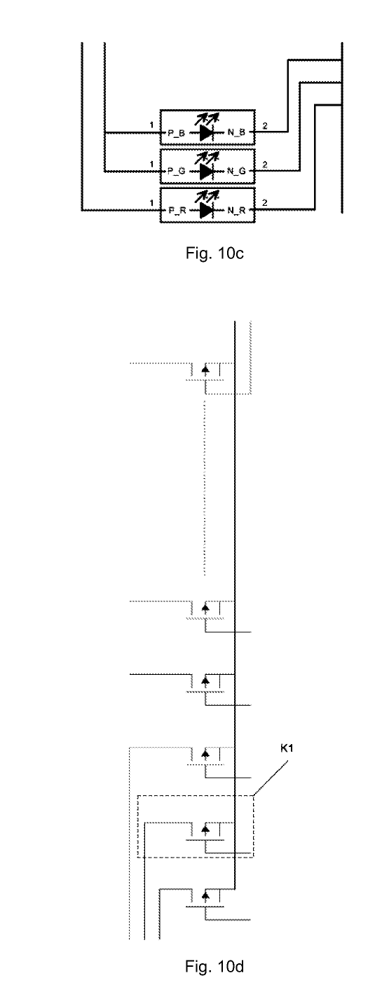

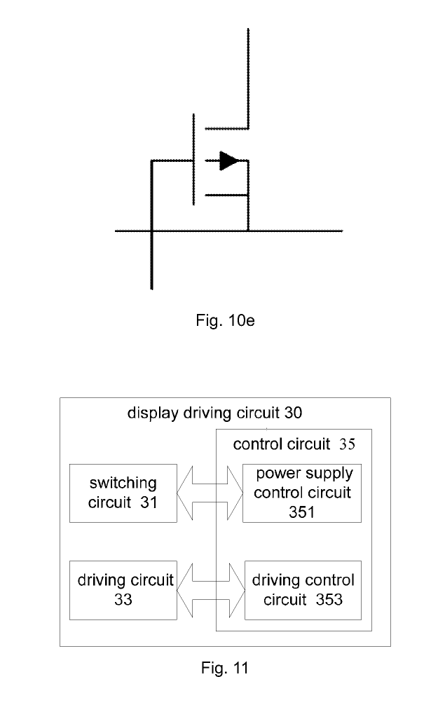

FIG. 9a to FIG. 9c are structure schematic diagrams of an LED display according to embodiment 7 of the invention, and FIG. 10a to FIG. 10e are structure schematic diagrams of an LED display according to embodiment 7 of the invention. FIG. 9b and FIG. 10b show partial enlarged drawings of a part I covered by a dashed line in FIG. 9a and a part J covered by a dashed line in FIG. 10a in the two embodiments respectively, LEDs in three primary colors in an LED particle in FIG. 9c are directly integrated on the LED particle, the LEDs in the three primary colors in an LED particle in FIG. 10c are encapsulated and integrated on the LED particle respectively, but beyond that, the same circuit connection relationship can be adopted in the two implementation modes. In the above, the anode of each LED particle in FIG. 9c and FIG. 9b has three pins, i.e. 1, 2 and 3 respectively, corresponding to the anodes of the internal R/G/B three primary colors LEDs respectively, and the cathode of each LED particle in FIG. 9c and FIG. 9b has three pins, i.e. 4, 5 and 6 respectively, corresponding to the cathodes of the internal B/G/R primary color LEDs respectively; and as shown in FIG. 10c, the anodes of the R/G/B primary color LEDs are pins 1, the cathodes of the R/G/B primary color LEDs are pins 2, and the R/G/B primary color LEDs are welded in parallel as the LED particles (i.e. full-color pixels).

Specifically, the display driving circuit 30 integrates three constant current channel groups which control the constant current display of the R/G/B three primary colors LEDs on the LED display panel 10 respectively, integrates two groups of P-MOS channels which are configured to control the power supply of the R/G/B three primary colors LEDs on the LED display panel 10 respectively, and integrates the control circuit 35 which is configured to control the coordinated work of the constant current channel groups and the P-MOS transistor channels.

In embodiments 5 and 6, FIG. 10d shows the field effect transistors on the part K covered by the dashed line in FIG. 10a can be P-MOS transistors, FIG. 10e shows the structure of the P-MOS transistor on the part K1 covered by the dashed line in FIG. 10d, the LED display panel 10 includes M lines*N columns of LED particles, and each LED particle includes a red lamp tube, a green lamp tube and a blue lamp tube, wherein an anode of a red lamp tube in each LED particle in each line is connected in parallel, and is connected with a drain of a corresponding P-MOS transistor in the first switching sub-circuit respectively; the anodes of a green lamp tube and a blue lamp tube in each LED particle in each line are connected in parallel, as a connection terminal of an anode of the LED display panel 10, and are connected with the a of a corresponding P-MOS transistor in the second switching sub-circuit; a cathode of a red lamp tube of each LED particle in each column is connected in parallel respectively, and is connected with a second end of a corresponding constant current logic component in the first constant current channel group respectively; a cathode of a green lamp tube of each LED particle in each column is connected in parallel respectively, and is connected with a second end of a corresponding constant current logic component in a second constant current channel group respectively; and a cathode of a blue lamp tube of each LED particle in each column is connected in parallel respectively, and is connected with a second end of a corresponding constant current logic component in the third constant current channel group respectively.

The first switching sub-circuit includes one or more P-MOS transistors, the sources of these P-MOS transistors are interconnected to an external pin VCCB of the display driving circuit 30, the gates of the P-MOS transistors are connected to the first power supply control port, and the drains of the P-MOS transistors are connected to the R primary color anodes of the LED particles (the LED particles in a single line or in multiple lines in FIG. 9a) in the corresponding lines in the LED display panel 10; and the second switching sub-circuit includes one or more P-MOS transistors, the sources of these P-MOS transistors are interconnected to an external pin VCCA of the display driving circuit 30, the gates of the P-MOS transistors are connected to the second power supply control port, and the drains of the P-MOS transistors are connected to the G and B primary color anodes of the LED particles (the LED particles in a single line or in multiple lines in FIG. 9a) in the corresponding lines in the LED display panel 10.

In addition, the R primary color constant current channel group can include one or more constant current logic components, the input ends of these constant current logic components are connected to the R primary color cathodes of the LED particles in the corresponding columns in the LED display panel 10, the output ends of the constant current logic components are interconnected to the external pin GND of the display driving circuit 30, and the control ends of the constant current logic circuits are connected to the first R display control sub-port; the G primary color constant current channel group can include one or more constant current logic components, the input ends of these constant current logic components are connected to the G primary color cathodes of the LED particles in the corresponding columns in the LED display panel 10, the output ends of the constant current logic components are interconnected to the external pin GND of the display driving circuit 30, and the control ends of the constant current logic circuits are connected to the first G display control sub-port; and the B primary color constant current channel group can include one or more constant current logic components, the input ends of these constant current logic components are connected to the B primary color cathodes of the LED particles in the corresponding columns in the LED display panel 10, the output ends of the constant current logic components are interconnected to the external pin GND of the display driving circuit 30, and the control ends of the constant current logic circuits are connected to the first B display control sub-port.

Under the control of the display driving circuit 30, the power supply control circuit 351 controls the corresponding two P-MOS transistors, which correspond to the same line in the first switching sub-circuit 31 and the second switching sub-circuit 31, to be in an turn-on state through the power supply control port to supply power to the anodes of the R primary color LEDs and the G/B primary color LEDs of the LED particles in the corresponding line on the LED display panel 10 respectively, and the driving control circuit 353 outputs an R display control signal/G display control signal/B display control signal to each constant current logic component in the first constant current channel group/second constant current channel group/third constant current channel group through the second R display control sub-port/second G display control sub-port/second B display control sub-port to respectively control each constant current logic component in the three constant current channel groups to be in an turned on working state, thereby providing the current paths for the R primary color cathodes, G primary color cathodes and B primary color cathodes of the LED particles in the corresponding columns and realizing the ordered display of the LED particles.

In the implementation mode, power supply voltages of the first switching sub-circuit and the second switching sub-circuit can be different, a power supply voltage of VCCB is preferably 1.6V, and can be lower than that of the pin VCCA, and 1.6V is obtained by subtracting a typical working voltage (1.8-2V) of the red lamp tubes from the typical working voltages (3.4-3.6V) of the green or blue lamp tubes, so that the power supply voltages of the R/G/B primary color LEDs can be differentially controlled to further reduce the power consumption of the LED display.

In addition, the implementation modes shown in embodiments 5 and 6 can also be transformed as follows:

the field effect transistors in the LED display can be P-MOS transistors, the LED display panel 10 can include M lines*N columns of LED particles, and each LED particle includes a red lamp tube, a green lamp tube and a blue lamp tube respectively, wherein the anode of the red lamp tube in the ith LED particle in each line is connected in parallel with the ith joint, and each joint in each line is connected in parallel, and is connected with a drain of a corresponding P-MOS transistor in the first switching sub-circuit 31; the anodes of the green lamp tube and the blue lamp tube in the jth LED particle in each line are connected in parallel with the jth joint, and each joint in each line is connected in parallel, and is connected with a drain of a corresponding P-MOS transistor in the second switching sub-circuit 31 respectively; the cathode of the red lamp tube of each LED particle in each column is connected in parallel, and is connected with a second end of a corresponding constant current logic component in the first constant current channel group respectively; the cathode of the green lamp tube of each LED particle in each column is connected in parallel, and is connected with a second end of a corresponding constant current logic component in the second constant current channel group respectively; and the cathode of the blue lamp tube of each LED particle in each column is connected in parallel, and is connected with a second end of a corresponding constant current logic component in the third constant current channel group respectively.

Furthermore, the power supply voltage of the external pin VCCB of the display driving circuit 30 can be lower than that of the external pin VCCA, and is preferably 1.6V which is obtained by subtracting the typical working voltage (1.8-2V) of the red lamp tubes from the typical working voltages (3.4-3.6V) of the green or blue lamp tubes, and the power supply voltages of the R/G/B primary color LEDs are differentially controlled, thereby reducing the power consumption of the LED display.

Based on the implementation modes shown in embodiments 5 and 6, there can also be two transformations as follows:

the field effect transistors can also be N-MOS transistors, the LED display panel 10 includes M lines*N columns of LED particles, and each LED particle includes a red lamp tube, a green lamp tube and a blue lamp tube respectively, wherein the cathode of the red lamp tube in the ith LED particle in each line is connected in parallel with the ith joint, and each joint in each line is connected in parallel, and is connected with a drain of a corresponding N-MOS transistor in the first switching sub-circuit 31; the cathodes of the green lamp tube and the blue lamp tube in the jth LED particle in each line are connected in parallel with the jth joint, and each joint in each line is connected in parallel, and is connected with a drain of a corresponding N-MOS transistor in the second switching sub-circuit 31; an anode of a red lamp tube of each LED particle in each column is connected in parallel, and is connected with a second end of a corresponding constant current logic component in the first constant current channel group respectively; an anode of a green lamp tube of each LED particle in each column is connected in parallel, and is connected with a second end of a corresponding constant current logic component in the second constant current channel group respectively; and an anode of a blue lamp tube of each LED particle in each column is connected in parallel, and is connected with a second end of a corresponding constant current logic component in the third constant current channel group respectively.

Specifically, in the embodiment, the first switching sub-circuit includes one or more N-MOS transistors, the sources of these N-MOS transistors are interconnected to the external pin GND of the display driving circuit 30, the gates of the N-MOS transistors are connected to the first power supply control port, and the drains of the N-MOS transistors are connected to the R primary color anodes of the LED particles (the LED particles in a single line or in multiple lines in FIG. 10a) in the corresponding lines in the LED display panel 10; and the second switching sub-circuit includes one or more N-MOS transistors, the sources of these N-MOS transistors are interconnected to the external pin GND of the display driving circuit 30, the gates of the N-MOS transistors are connected to the second power supply control port, and the drains of the N-MOS transistors are connected to the G and B primary color anodes of the LED particles (the LED particles in a single line or in multiple lines in FIG. 10a) in the corresponding lines in the LED display panel 10.

In addition, the R primary color constant current channel group can include one or more constant current logic components, the input ends of these constant current logic components are connected to the R primary color cathodes of the LED particles in the corresponding columns in the LED display panel 10, the output ends of the constant current logic components are interconnected to the external pin VCCR of the display driving circuit 30, and the control ends of the constant current logic circuits are connected to the first R display control sub-port; the G primary color constant current channel group can include one or more constant current logic components, the input ends of these constant current logic components are connected to the G primary color cathodes of the LED particles in the corresponding columns in the LED display panel 10, the output ends of the constant current logic components are interconnected to the external pin VCCG of the display driving circuit 30, and the control ends of the constant current logic circuits are connected to the first G display control sub-port; and the B primary color constant current channel group can include one or more constant current logic components, the input ends of these constant current logic components are connected to the B primary color cathodes of the LED particles in the corresponding columns in the LED display panel 10, the output ends of the constant current logic components are interconnected to the external pin VCCB of the display driving circuit 30, and the control ends of the constant current logic circuits are connected to the first B display control sub-port.

In the above, the power supply voltage of the external pin VCCR is lower than that of the external pin VCCR/VCCB, and is preferably 1.6V which is obtained by subtracting the typical working voltage (1.8-2V) of the red lamp tubes from the typical working voltages (3.4-3.6V) of the green or blue lamp tubes, and the power supply voltages of the R/G/B primary color LEDs are differentially controlled, thereby reducing the power consumption of the LED display.

Specifically, the cathode of the red lamp tube in the ith LED particle in each line is connected in parallel with the ith joint, and each joint in each line is connected in parallel, and is connected with a drain of a corresponding N-MOS transistor in the first switching sub-circuit 31 respectively; the cathodes of the green lamp tube and the blue lamp tube in the jth LED particle in each line are connected in parallel with the jth joint, and each joint in each line is connected in parallel, and is connected with a drain of a corresponding N-MOS transistor in the second switching sub-circuit 31; the common anodes of the R primary color LEDs in the LED particles in a single column are interconnected to an input end of a constant current logic component of the first constant current channel group of the display driving circuit 30; the common anodes of the G primary color LEDs in the LED particles in a single column are interconnected to an input end of a constant current logic component of the second constant current channel group of the display driving circuit 30; and the common anodes of the B primary color LEDs in the LED particles in a single column are interconnected to an input end of a constant current logic component of the third constant current channel group of the display driving circuit 30.

In addition, embodiment 8 can be implemented by a method as follows: the field effect transistors can be N-MOS transistors, the LED display panel 10 includes M lines*N columns of LED particles, and each LED particle includes a red lamp tube, a green lamp tube and a blue lamp tube respectively, wherein the cathode of the red lamp tube in each LED particle in each line is connected in parallel, and is connected with a drain of a corresponding N-MOS transistor in the first switching sub-circuit 31 respectively; the cathodes of the green lamp tube and the blue lamp tube in each LED particle in each line are connected in parallel, and are connected with a drain of a corresponding N-MOS transistor in the second switching sub-circuit 31 respectively; an anode of a red lamp tube of each LED particle in each column is connected in parallel respectively, and is connected with a second end of a corresponding constant current logic component in the first constant current channel group respectively; an anode of a green lamp tube of each LED particle in each column is connected in parallel respectively, and is connected with a second end of a corresponding constant current logic component in the second constant current channel group respectively; and an anode of a blue lamp tube of each LED particle in each column is connected in parallel respectively, and is connected with a second end of a corresponding constant current logic component in the third constant current channel group respectively.

Specifically, a cathode of a red lamp tube in each LED particle in each line is internally interconnected, and is connected with a drain of a corresponding N-MOS transistor in the first switching sub-circuit 31 respectively, and the cathodes of a green lamp tube and a blue lamp tube in each LED particle in each line are interconnected, and are connected with a drain of a corresponding N-MOS transistor in the second switching sub-circuit 31 respectively; the common anodes of the R primary color LEDs in the LED particles in a single column are interconnected, and is connected to an input end of a constant current logic component of the first constant current channel group of the display driving circuit 30; the common anodes of the G primary color LEDs in the LED particles in a single column are interconnected, and is connected to an input end of a constant current logic component of the second constant current channel group of the display driving circuit 30; and the common anodes of the B primary color LEDs in the LED particles in a single column is interconnected, and are connected to an input end of a constant current logic component of the third constant current channel group of the display driving circuit 30.

The LED particles in the LED display according to the embodiment of the invention include the red lamp tubes, the green lamp tubes and the blue lamp tubes, wherein the red lamp tubes, the green lamp tubes and the blue lamp tubes can be integrated in the LED particles, and can also be arranged in the LED particles after being independently encapsulated respectively.

In embodiments 1 to 6, the field effect transistors in FIG. 6a, FIG. 7a and FIG. 8a can be the N-MOS transistors shown in FIG. 7c respectively, and the field effect transistors in FIG. 5a, FIG. 9a and FIG. 10a can be the P-MOS transistors shown in FIG. 10c respectively.

FIG. 11 is a structure schematic diagram of an LED control system according to the embodiment of the invention. As shown in FIG. 11, the LED control system includes: a display driving circuit 30, the display driving circuit 30 including: a switching circuit 31, a driving circuit 33 and a control circuit 35, wherein a first end of one of the switching circuit 31 and the driving circuit 33 is connected to a power end of a power supply equipment, and a first end of the other of the switching circuit 31 and the driving circuit 33 is connected to a grounding end of the power supply equipment; a second end of one of the switching circuit 31 and the driving circuit 33 is connected with an anode of an LED display panel 10, and a second end of the other of the switching circuit 31 and the driving circuit 33 is connected to a cathode of the LED display panel 10; wherein the switching circuit 31 is configured to control the power supply of the LED display panel 10, and the driving circuit 33 is configured to control the ordered display of the LED display panel 10; the control circuit includes: a power supply control circuit 351 and a driving control circuit 353; wherein the power supply control circuit 351 is connected with a third end of the switching circuit 31 through a power supply control port, for controlling the switching-on or switching-off of the switching circuit 31; and the driving control circuit 353 is connected with a third end of the driving circuit 33 through a driving control port, for controlling the turning-on or cutting-off of the driving circuit 33.

According to the LED control system of the disclosure, the display driving circuit 30 in the LED control system includes the switching circuit 31, the driving circuit 33 and the control circuit 35, wherein the control circuit 35 includes the power supply control circuit 351 and the driving control circuit 353; the power supply control circuit 351 is configured to control the switching-on or switching-off of the switching circuit 31; and the driving control circuit 353 is configured to control the turning-on or cutting-off of the driving circuit 33, then the power supply of the LED display panel 10 is controlled by switching on or switching off the switching circuit 31 and the display of the LED display panel 10 is controlled by turning-on on or cutting off the driving circuit 33, thereby realizing the ordered display of the LED display panel 10. By the LED control system of the disclosure, the switching circuit 31, the driving circuit 33 and the control circuit 35 are integrated in the display driving circuit 30, and then more display driving circuits 30 can be placed under the condition of not changing an area of the LED display panel 10, so that a number ratio of the LED particles and the display driving circuits 30 on the LED display with a fixed area is reduced, and a refreshing rate is increased; moreover, a connection relationship between the display driving circuits 30 and the LED particle array with M lines*N columns in the LED display panel is clearer, and fewer connection lines are required, so that the design difficulty of a PCB is decreased. The problem of large PCB area occupied by the control circuit 35, low refreshing rate and high power consumption of the LED display in the related art is solved, and the effects of small PCB area occupied by the control circuit 35, simple design and high refreshing rate of the LED display are achieved.

From the above, it can be seen that the disclosure achieves technical effects as follows: by the LED display and the LED control system of the disclosure, the switching circuit 31, the driving circuit 33 and the control circuit 35 are integrated in the display driving circuit 30, and then more display driving circuits 30 can be placed under the condition of not changing the area of the LED display panel 10, so that the number ratio of the LED particles and the display driving circuits 30 on the LED display with a fixed area is reduced, and the refreshing rate is increased; moreover, a connection relationship between the display driving circuits 30 and the LED particle array with M lines*N columns in the LED display panel is clearer, and fewer connection lines are required, so that the design difficulty of the PCB is decreased. The problem of large PCB area occupied by the control circuit 35, low refreshing rate and high power consumption of the LED display in the related art is solved, and the effects of small PCB area occupied by the control circuit 35, simple design and high refreshing rate of the LED display are achieved.

The above is only the preferred embodiment of the invention and not intended to limit the disclosure. For those skilled in the art, the disclosure can have various modifications and variations. Any modifications, equivalent replacements, improvements and the like within the spirit and principle of the disclosure shall fall within the scope of protection of the disclosure.

1. A Light-Emitting Diode (LED) display, comprising:
an LED display panel; and
a display driving circuit, comprising a switching circuit, a driving circuit and a control circuit, wherein
a first end of one of the switching circuit and the driving circuit is connected to a power end of a power supply equipment, and a first end of the other of the switching circuit and the driving circuit is connected to a grounding end of the power supply equipment;
a second end of one of the switching circuit and the driving circuit is connected with an anode of the LED display panel, and a second end of the other of the switching circuit and the driving circuit is connected with a cathode of the LED display panel;
the control circuit comprises a power supply control circuit and a driving control circuit; wherein
the power supply control circuit is connected with a third end of the switching circuit through a power supply control port, and is configured to control the switching-on or switching-off of the switching circuit;
the driving control circuit is connected with a third end of the driving circuit through a driving control port, and is configured to control the turning-on or cutting-off of the driving circuit; and
wherein the switching circuit is configured to control the power supply of the LED display panel, and the driving circuit is configured to control the ordered display of the LED display panel.

2. The display according to claim 1, wherein the switching circuit comprises a switching sub-circuit, and the switching sub-circuit comprises one or more field effect transistors, wherein;
a source of each of the field effect transistors is connected with the power end or grounding end of the power supply equipment respectively;
a drain of each of the field effect transistors is connected with an anode or cathode of each LED particle in a corresponding line in the LED display panel respectively; and
a gate of each of the field effect transistors is connected with a corresponding connection terminal in the power supply control port respectively.

3. The display according to claim 2, wherein the driving circuit comprises a constant current channel group, and the constant current channel group comprises one or more constant current logic components; wherein
a first end of each of the constant current logic components is connected with the power end or grounding end of the power supply equipment respectively;
a second end of each of the constant current logic components is connected with an anode or cathode of an LED particle in a corresponding column in the LED display panel respectively; and
a third end of each of the constant current logic components is connected with a corresponding connection terminal in the driving control port respectively.

4. The display according to claim 3, wherein
the power supply control circuit is configured to control each of the field effect transistors to be switched on to supply power to LED particles in a line corresponding to the each of the field effect transistors in the LED display panel; and
the driving control circuit is configured to control each of the constant current logic components in the constant current channel group to be turned on, and each of the constant current logic components provides a current path for LED particles in a column corresponding to the each of the constant current logic components in the LED display panel respectively to control the ordered display of the LED particles after being turned on.

5. The display according to claim 2, wherein the field effect transistors are P-channel Metal Oxide Semiconductor (P-MOS) transistors, the LED display panel comprises LED particles with M lines and N columns, and each of the LED particles respectively comprises a red lamp tube, a green lamp tube and a blue lamp tube, wherein;
an anode of the red lamp tube, an anode of the green lamp tube and an anode of the blue lamp tube in the ith LED particle in each line are connected in parallel with the ith joint, and each joint in each line is connected in parallel, and is connected with a drain of corresponding one of the P-MOS transistors in the switching circuit respectively;
a cathode of the red lamp tube of each of the LED particles in each column is connected in parallel respectively, and is connected with a second end of corresponding one of the constant current logic components in the constant current channel group respectively;
a cathode of the green lamp tube of each of the LED particles in each column is connected in parallel respectively, and is connected with a second end of corresponding one of the constant current logic components in the constant current channel group respectively; and
a cathode of the blue lamp tube of each of the LED particles in each column is connected in parallel respectively, and is connected with a second end of corresponding one of the constant current logic components in the constant current channel group respectively.

6. The display according to claim 2, wherein the field effect transistors are P-MOS transistors, the LED display panel comprises LED particles with M lines and N columns, and each of the LED particle respectively comprises a red lamp tube, a green lamp tube and a blue lamp tube, wherein;
an anode of the red lamp tube, an anode of the green lamp tube and an anode of the blue lamp tube in each of the LED particles in each line are connected in parallel, and are connected with a drain of corresponding one of the P-MOS transistors in the switching circuit;
a cathode of the red lamp tube of each of the LED particles in each column is connected in parallel respectively, and is connected with a second end of corresponding one of the constant current logic components in the constant current channel group respectively;
a cathode of the green lamp tube of each of the LED particles in each column is connected in parallel respectively, and is connected with a second end of corresponding one of the constant current logic components in the constant current channel group respectively; and
a cathode of the blue lamp tube of each of the LED particles in each column is connected in parallel respectively, and is connected with a second end of corresponding one of the constant current logic components in the constant current channel group respectively.

7. The display according to claim 2, wherein the field effect transistors are N-channel Metal Oxide Semiconductor (N-MOS) transistors, the LED display panel comprises LED particles with M lines and N columns, and each of the LED particles respectively comprises a red lamp tube, a green lamp tube and a blue lamp tube;
a cathode of the red lamp tube, a cathode of the green lamp tube and a cathode of the blue lamp tube in the ith LED particle in each line are connected in parallel with the ith joint, and each joint in each line is connected in parallel, and is connected with a drain of corresponding one of the N-MOS transistors in the switching circuit;
an anode of the red lamp tube of each of the LED particles in each column is connected in parallel respectively, and is connected with a second end of corresponding one of the constant current logic components in the constant current channel group respectively;
an anode of the green lamp tube of each of the LED particles in each column is connected in parallel respectively, and is connected with a second end of corresponding one of the constant current logic components in the constant current channel group respectively; and
an anode of the blue lamp tube of each of the LED particles in each column is connected in parallel respectively, and is connected with a second end of corresponding one of the constant current logic components in the constant current channel group respectively.

8. The display according to claim 2, wherein the field effect transistors are N-MOS transistors, the LED display panel comprises LED particles with M lines and N columns, and each of the LED particles respectively comprises a red lamp tube, a green lamp tube and a blue lamp tube; wherein
a cathode of the red lamp tube, a cathode of the green lamp tube and a cathode of the blue lamp tube in each of the LED particles in each line are connected in parallel, and are connected with a drain of corresponding one of the N-MOS transistors in the switching circuit;
an anode of the red lamp tube of each of the LED particles in each column is connected in parallel respectively, and is connected with a second end of corresponding one of the constant current logic components in the constant current channel group respectively;
an anode of the green lamp tube of each of the LED particles in each column is connected in parallel respectively, and is connected with a second end of corresponding one of the constant current logic components in the constant current channel group respectively; and
an anode of the blue lamp tube of each of the LED particles in each column is connected in parallel respectively, and is connected with a second end of corresponding one of the constant current logic components in the constant current channel group respectively.

9. The display according to claim 2, wherein the driving circuit comprises a first constant current channel group, a second constant current channel group and a third constant current channel group; wherein
the first constant current channel group comprises one or more constant current logic components, wherein a first end of each of the constant current logic components is respectively connected with the power end or grounding end of the power supply equipment, a third end of each of the constant current logic components is respectively connected with a first R display control sub-port of the driving control port, and a second end of each of the constant current logic components is respectively connected with the anode or cathode of the red lamp tube in each of the LED particles in a corresponding column in the LED display panel, for controlling the display of Red lamp tubes of the LED display panel;
the second constant current channel group comprises one or more constant current logic components, wherein a first end of each of the constant current logic components is respectively connected with the power end or grounding end of the power supply equipment, a third end of each of the constant current logic components is respectively connected with a first G display control sub-port of the driving control port, and a second end of each of the constant current logic components is respectively connected with the anode or cathode of the green lamp tube in each of the LED particles in a corresponding column in the LED display panel, for controlling the display of green lamp tubes of the LED display panel; and
the third constant current channel group comprises one or more constant current logic components, a first end of each of the constant current logic components is respectively connected with the power end or grounding end of the power supply equipment, a third end of each of the constant current logic components is respectively connected with a first B display control sub-port of the driving control port, and a second end of each of the constant current logic components is respectively connected with the anode or cathode of the blue lamp tube in each of the LED particles in a corresponding column in the LED display panel, for controlling the display of blue lamp tubes of the LED display panel.

10. The display according to claim 9, wherein
the power supply control circuit controls each of the field effect transistors to be switched on to supply power to the LED particles in lines corresponding to the field effect transistors in the LED display panel;
the driving control circuit is configured to control each of the constant current logic components in the first constant current channel group to be turned on through the first R display control sub-port, and each of the constant current logic components is turned on to respectively provide a current path for the red lamp tubes in the LED particles in the column corresponding to the constant current logic component in the LED display panel, so as to control the display of the red lamp tubes of the LED particles in the line corresponding to the field effect transistor in the LED display panel;
the driving control circuit is further configured to control each of the constant current logic components in the second constant current channel group to be turned on through the first G display control sub-port, and each of the constant current logic components is turned on to respectively provide a current path for the green lamp tubes in the LED particles in the column corresponding to the constant current logic component in the LED display panel, so as to control the display of the green lamp tubes of the LED particles in the line corresponding to the field effect transistor in the LED display panel; and
the driving control circuit is further configured to control each of the constant current logic components in the third constant current channel group to be turned on through the first B display control sub-port, and each of the constant current logic components is turned on to respectively provide a current path for the blue lamp tubes in the LED particles in the column corresponding to the constant current logic component in the LED display panel, so as to control the display of the blue lamp tubes of the LED particles in the line corresponding to the field effect transistor in the LED display panel.

11. The display according to claim 9, wherein the field effect transistors are P-MOS transistors, the LED display panel comprises LED particles with M lines and N columns, and each of the LED particles comprises a red lamp tube, a green lamp tube and a blue lamp tube respectively; wherein
an anode of the red lamp tube, an anode of the green lamp tube and an anode of the blue lamp tube in the ith LED particle in each line are connected in parallel with the ith joint, and each joint in each line is connected in parallel, and is connected with a drain of corresponding one of the P-MOS transistors in the switching circuit respectively;
a cathode of the red lamp tube of each of the LED particles in each column is connected in parallel respectively, and is connected with a second end of corresponding one of the constant current logic components in the first constant current channel group respectively;
a cathode of the green lamp tube of each of the LED particles in each column is connected in parallel respectively, and is connected with a second end of corresponding one of the constant current logic components in the second constant current channel group respectively; and
a cathode of the blue lamp tube of each of the LED particles in each column is connected in parallel respectively, and is connected with a second end of corresponding one of the constant current logic components in the third constant current channel group respectively.

12. The display according to claim 9 or 10, wherein the field effect transistors are P-MOS transistors, the LED display panel comprises LED particles with M lines and N columns, and each of the LED particles comprises an red lamp tube, a green lamp tube and a blue lamp tube respectively; wherein
an anode of the red lamp tube, an anode of the green lamp tube and an anode of the blue lamp tube in each of the LED particles in each line are connected in parallel, and are connected with a drain of corresponding one of the P-MOS transistors in the switching circuit respectively;
a cathode of the red lamp tube of each of the LED particles in each column is connected in parallel respectively, and is connected with a second end of corresponding one of the constant current logic components in the first constant current channel group respectively;
a cathode of the green lamp tube of each of the LED particles in each column is connected in parallel respectively, and is connected with a second end of corresponding one of the constant current logic components in the second constant current channel group respectively; and
a cathode of the blue lamp tube of each of the LED particles in each column is connected in parallel respectively, and is connected with a second end of corresponding one of the constant current logic components in the third constant current channel group respectively.

13. The display according to claim 9, wherein the field effect transistors are N-MOS transistors, the LED display panel comprises LED particles with M lines and N columns, and each of the LED particles comprises a red lamp tube, a green lamp tube and a blue lamp tube respectively, wherein;
a cathode of the red lamp tube, a cathode of the green lamp tube and a cathode of the blue lamp tube in the ith LED particle in each line are connected in parallel with the ith joint, and each joint in each line is connected in parallel, and is connected with a drain of corresponding one of the N-MOS transistors in the switching circuit respectively;
an anode of the red lamp tube of each of the LED particles in each column is connected in parallel respectively, and is connected with a second end of corresponding one of the constant current logic components in the first constant current channel group respectively as a connection terminal of the anode of the LED display panel;
an anode of the green lamp tube of each of the LED particles in each column is connected in parallel respectively, and is connected with a second end of corresponding one of the constant current logic components in the second constant current channel group respectively as a connection terminal of the anode of the LED display panel; and
an anode of the blue lamp tube of each of the LED particles in each column is connected in parallel respectively, and is connected with a second end of corresponding one of the constant current logic components in the third constant current channel group respectively as a connection terminal of the anode of the LED display panel.

14. The display according to claim 9, wherein the field effect transistors are N-MOS transistors, the LED display panel comprises LED particles with M lines and N columns, and each of the LED particles comprises a red lamp tube, a green lamp tube and a blue lamp tube respectively, wherein;
a cathode of the red lamp tube, a cathode of the green lamp tube and a cathode of the blue lamp tube in each of the LED particles in each line are connected in parallel, and are connected with a drain of corresponding one of the N-MOS transistors in the switching circuit respectively;
an anode of the red lamp tube of each of the LED particles in each column is connected in parallel respectively, and is connected with a second end of corresponding one of the constant current logic components in the first constant current channel group respectively;
an anode of the green lamp tube of each of the LED particles in each column is connected in parallel respectively, and is connected with a second end of corresponding one of the constant current logic components in the second constant current channel group respectively; and
an anode of the blue lamp tube of each of the LED particles in each column is connected in parallel respectively, and is connected with a second end of corresponding one of the constant current logic components in the third constant current channel group respectively.

15. The display according to claim 1, wherein the switching circuit comprises a first switching sub-circuit and a second switching sub-circuit; wherein
each of the first switching sub-circuit and the second switching sub-circuit comprises one or more field effect transistors; and a source of each of the field effect transistors in the first switching sub-circuit and the second switching sub-circuit is connected with the power end or grounding end of the power supply equipment respectively;
wherein a drain of each of the field effect transistors in the first switching sub-circuit is respectively connected with an anode or cathode of the red lamp tube in each of the LED particles in a corresponding line in the LED display panel, and a gate of each of the field effect transistors is respectively connected with a corresponding connection terminal in the power supply control port, for controlling the power supply of the red lamp tube of the LED display panel; and
a drain of each of the field effect transistors in the second switching sub-circuit is respectively connected with an anode or cathode of the green lamp tube and the blue lamp tube in each of the LED particles in a corresponding line in the LED display panel, and a gate of each of the field effect transistors is respectively connected with a corresponding connection terminal in the power supply control port, for controlling the power supply of the green lamp tube and the blue lamp tube of the LED display panel.

16. The display according to claim 15, wherein the driving circuit comprises a constant current channel group, and the constant current channel group comprises: one or more constant current logic components; wherein
a first end of each of the constant current logic components is connected with the power end or grounding end of the power supply equipment respectively;
a second end of each of the constant current logic components is connected with an anode or cathode of the LED particles in a corresponding column in the LED display panel respectively; and
a third end of each of the constant current logic components is connected with a corresponding connection terminal in the driving control port respectively.

17. The display according to claim 16, wherein
the power supply control circuit is configured to control one of the field effect transistors in the first switching sub-circuit to be switched on to supply power to red lamp tubes in LED particles in a line corresponding to the one of the field effect transistors in the first switching sub-circuit in the LED display panel;
the power supply control circuit is further configured to control a field effect transistor, which corresponds to the one of the field effect transistors in the first switching sub-circuit, in the second switching sub-circuit to be switched on to supply power to the green lamp tubes and the blue lamp tubes in the LED particles in a line, which corresponds to the one of the field effect transistors in the first switching sub-circuit, in the LED display panel; and
the driving control circuit is configured to control each of the constant current logic components in the constant current channel group to be turned on, and each of the constant current logic components provides a current path for the LED particles in a column corresponding to the constant current logic component in the LED display panel respectively after the each of the constant current logic components is turned on, so as to control the ordered display of the LED particles in the line corresponding to the field effect transistor in the LED display panel.

18. The display according to claim 15, wherein the field effect transistors are P-MOS transistors, the LED display panel comprises LED particles with M lines and N columns, and each of the LED particles respectively comprises a red lamp tube, a green lamp tube and a blue lamp tube;
an anode of the red lamp tube in the ith LED particle in each line is connected in parallel with the ith joint, and each joint in each line is connected in parallel, and is connected with a drain of corresponding one of the P-MOS transistors in the first switching sub-circuit respectively;
an anode of the green lamp tube and an anode of the blue lamp tube in the jth LED particle in each line are connected in parallel with the jth joint, and each joint in each line is connected in parallel, and is connected with a drain of corresponding one of the P-MOS transistors in the second switching sub-circuit respectively;
a cathode of the red lamp tube of each of the LED particles in each column is connected in parallel respectively, and is connected with a second end of corresponding one of the constant current logic components in the constant current channel group respectively;
a cathode of the green lamp tube of each of the LED particles in each column is connected in parallel respectively, and is connected with a second end of corresponding one of the constant current logic components in the constant current channel group respectively; and
a cathode of the blue lamp tube of each of the LED particles in each column is connected in parallel respectively, and is connected with a second end of corresponding one of the constant current logic components in the constant current channel group respectively.

19. The display according to claim 15, wherein the field effect transistors are P-MOS transistors, the LED display panel comprises LED particles with M lines and N columns, and each of the LED particles comprises a red lamp tube, a green lamp tube and a blue lamp tube; wherein
an anode of the red lamp tube in each of the LED particles in each line is connected in parallel, and is connected with a drain of corresponding one of the P-MOS transistors in the first switching sub-circuit respectively;
an anode of the green lamp tube and an anode of the blue lamp tube in each of the LED particles in each line are connected in parallel, and are connected with a drain of corresponding one of the P-MOS transistors in the second switching sub-circuit respectively;
a cathode of the red lamp tube of each of the LED particles in each column is connected in parallel respectively, and is connected with a second end of corresponding one of the constant current logic components in the constant current channel group respectively;
a cathode of the green lamp tube of each of the LED particles in each column is connected in parallel respectively, and is connected with a second end of corresponding one of the constant current logic components in the constant current channel group respectively; and
a cathode of the blue lamp tube of each of the LED particles in each column is connected in parallel respectively, and is connected with a second end of corresponding one of the constant current logic components in the constant current channel group respectively.

20. The display according to claim 15, wherein the field effect transistors are N-MOS transistors, the LED display panel comprises LED particles with M lines and N columns, and each of the LED particles respectively comprises a red lamp tube, a green lamp tube and a blue lamp tube;
a cathode of the red lamp tube in the ith LED particle in each line is connected in parallel with the ith joint, and each joint in each line is connected in parallel, and is connected with a drain of corresponding one of the N-MOS transistors in the first switching sub-circuit respectively;
a cathode of the green lamp tube and a cathode of the blue lamp tube in the jth LED particle in each line are connected in parallel with the jth joint, and each joint in each line is connected in parallel, and is connected with a drain of corresponding one of the N-MOS transistors in the second switching sub-circuit respectively;
an anode of the red lamp tube of each of the LED particles in each column is connected in parallel respectively, and is connected with a second end of corresponding one of the constant current logic components in the constant current channel group respectively;
an anode of the green lamp tube of each of the LED particles in each column is connected in parallel respectively, and is connected with a second end of corresponding one of the constant current logic components in the constant current channel group respectively; and
an anode of the blue lamp tube of each of the LED particles in each column is connected in parallel respectively, and is connected with a second end of corresponding one of the constant current logic components in the constant current channel group respectively.

21. The display according to claim 15, wherein the field effect transistors are N-MOS transistors, the LED display panel comprises LED particles with M lines and N columns, and each of the LED particles comprises a red lamp tube, a green lamp tube and a blue lamp tube;
a cathode of the red lamp tube in each of the LED particles in each line is connected in parallel, and is connected with a drain of corresponding one of the N-MOS transistors in the first switching sub-circuit respectively;
a cathode of the green lamp tube and a cathode of the blue lamp tube in each of the LED particles in each line are connected in parallel, and are connected with a drain of corresponding one of the N-MOS transistors in the second switching sub-circuit respectively;
an anode of the red lamp tube of each of the LED particles in each column is connected in parallel respectively, and is connected with a second end of corresponding one of the constant current logic components in the constant current channel group respectively;
an anode of the green lamp tube of each of the LED particles in each column is connected in parallel respectively, and is connected with a second end of corresponding one of the constant current logic components in the constant current channel group respectively; and
an anode of the blue lamp tube of each of the LED particles in each column is connected in parallel respectively, and is connected with a second end of corresponding one of the constant current logic components in the constant current channel group respectively.

22. The display according to claim 15, wherein the driving circuit comprises a first constant current channel group, a second constant current channel group and a third constant current channel group; wherein
the first constant current channel group comprises one or more constant current logic components, wherein a first end of each of the constant current logic components is connected with the power end or grounding end of the power supply equipment respectively, a third end of each of the constant current logic components is connected with a second R display control sub-port of the driving control port respectively, and a second end of each of the constant current logic components is connected with an anode or cathode of the red lamp tube in each of the LED particles in a corresponding column in the LED display panel respectively, for controlling the display of the red lamp tube of the LED display panel;
the second constant current channel group comprises one or more constant current logic components, wherein a first end of each of the constant current logic components is connected with the power end or grounding end of the power supply equipment respectively, a third end of each of the constant current logic components is connected with a second G display control sub-port of the driving control port respectively, and a second end of each of the constant current logic components is connected with an anode or cathode of the green lamp tube in each of the LED particles in a corresponding column in the LED display panel respectively, for controlling the display of the green lamp tube of the LED display panel; and
the third constant current channel group comprises one or more constant current logic components, wherein a first end of each of the constant current logic components is connected with the power end or grounding end of the power supply equipment respectively, a third end of each of the constant current logic components is connected with a second B display control sub-port of the driving control port respectively, and a second end of each of the constant current logic components is connected with an anode or cathode of the blue lamp tube in each of the LED particles in a corresponding column in the LED display panel respectively, for controlling the display of the blue lamp tube of the LED display panel.

23. The display according to claim 22, wherein
the power supply control circuit is configured to control one of the field effect transistors in the first switching sub-circuit to be switched on to supply power to the red lamp tubes in the LED particles in a line, which corresponds to the one of the field effect transistors in the first switching sub-circuit, in the LED display panel;
the power supply control circuit is further configured to control a field effect transistor, which corresponds to the one of the field effect transistors in the first switching sub-circuit, in the second switching sub-circuit to be switched on to supply power to the green lamp tubes and the blue lamp tubes in the LED particles in a line, which corresponds to the field effect transistor in the first switching sub-circuit, in the LED display panel;
the driving control circuit is configured to control each of the constant current logic components in the first constant current channel group to be turned on through the second R display control sub-port, and each of the constant current logic components provides a current path for the red lamp tubes in the LED particles in the column corresponding to the constant current logic component in the LED display panel respectively after the each of the constant current logic components is turned on, so as to control the display of the red lamp tubes of the LED particles in the line corresponding to the field effect transistor in the LED display panel;
the driving control circuit is further configured to control each of the constant current logic components in the second constant current channel group to be turned on through the second G display control sub-port, and each of the constant current logic components provides a current path for the green lamp tubes in the LED particles in the column corresponding to the constant current logic component in the LED display panel respectively after the each of the constant current logic components is turned on, so as to control the display of the green lamp tubes of the LED particles in the line corresponding to the field effect transistor in the LED display panel; and
the driving control circuit is further configured to control each of the constant current logic components in the third constant current channel group to be turned on through the second B display control sub-port, and each of the constant current logic components provides a current path for the blue lamp tubes in the LED particles in the column corresponding to the constant current logic component in the LED display panel respectively after the each of the constant current logic components is turned on, so as to control the display of the blue lamp tubes of the LED particles in the line corresponding to the field effect transistor in the LED display panel.

24. The display according to claim 23, wherein the field effect transistors are P-MOS transistors, the LED display panel comprises LED particles with M lines and N columns, and each of the LED particles respectively comprises a red lamp tube, a green lamp tube and a blue lamp tube;
an anode of the red lamp tube in the ith LED particle in each line is connected in parallel with the ith joint, and each joint in each line is connected in parallel, and is connected with a drain of corresponding one of the P-MOS transistors in the first switching sub-circuit;
an anode of the green lamp tube and an anode of the blue lamp tube in the jth LED particle in each line are connected in parallel with the jth joint, and each joint in each line is connected in parallel, and is connected with a drain of corresponding one of the P-MOS transistors in the second switching sub-circuit respectively;
a cathode of the red lamp tube of each of the LED particles in each column is connected in parallel respectively, and is connected with a second end of corresponding one of the constant current logic components in the first constant current channel group respectively;
a cathode of the green lamp tube of each of the LED particles in each column is connected in parallel respectively, and is connected with a second end of corresponding one of the constant current logic components in the second constant current channel group respectively; and
a cathode of the blue lamp tube of each of the LED particles in each column is connected in parallel respectively, and is connected with a second end of corresponding one of the constant current logic components in the third constant current channel group respectively.

25. The display according to claim 23, wherein the field effect transistors are P-MOS transistors, the LED display panel comprises LED particles with M lines and N columns, and each of the LED particles respectively comprises a red lamp tube, a green lamp tube and a blue lamp tube, wherein;
an anode of the red lamp tube in each of the LED particles in each line is connected in parallel, and is connected with a drain of corresponding one of the P-MOS transistors in the first switching sub-circuit respectively;
an anode of the green lamp tube and an anode of the blue lamp tube in each of the LED particles in each line are connected in parallel, and are connected with a drain of corresponding one of the P-MOS transistors in the second switching sub-circuit respectively as a connection terminal of the anode of the LED display panel;
a cathode of the red lamp tube of each of the LED particles in each column is connected in parallel respectively, and is connected with a second end of corresponding one of the constant current logic components in the first constant current channel group respectively;
a cathode of the green lamp tube of each of the LED particles in each column is connected in parallel respectively, and is connected with a second end of corresponding one of the constant current logic components in the second constant current channel group respectively; and
a cathode of the blue lamp tube of each of the LED particles in each column is connected in parallel respectively, and is connected with a second end of corresponding one of the constant current logic components in the third constant current channel group respectively.

26. The display according to claim 23, wherein the field effect transistors are N-MOS transistors, the LED display panel comprises LED particles with M lines and N columns, and each of the LED particles respectively comprises a red lamp tube, a green lamp tube and a blue lamp tube, wherein;
a cathode of the red lamp tube in the ith LED particle in each line is connected in parallel with the ith joint, and each joint in each line is connected in parallel, and is connected with a drain of corresponding one of the N-MOS transistors in the first switching sub-circuit respectively;
a cathode of the green lamp tube and a cathode of the blue lamp tube in the jth LED particle in each line are connected in parallel with the jth joint, and each joint in each line is connected in parallel, and is connected with a drain of corresponding one of the N-MOS transistors in the second switching sub-circuit respectively;
an anode of the red lamp tube of each of the LED particles in each column is connected in parallel respectively, and is connected with a second end of corresponding one of the constant current logic components in the first constant current channel group respectively;
an anode of the green lamp tube of each of the LED particles in each column is connected in parallel respectively, and is connected with a second end of corresponding one of the constant current logic components in the second constant current channel group respectively; and
an anode of the blue lamp tube of each of the LED particles in each column is connected in parallel respectively, and is connected with a second end of corresponding one of the constant current logic components in the third constant current channel group respectively.

27. The display according to claim 23, wherein the field effect transistors are N-MOS transistors, the LED display panel comprises LED particles with M lines and N columns, and each of the LED particles comprises a red lamp tube, a green lamp tube and a blue lamp tube, wherein;
a cathode of the red lamp tube in each of the LED particles in each line is connected in parallel, and is connected with a drain of corresponding one of the N-MOS transistors in the first switching sub-circuit respectively;
a cathode of the green lamp tube and a cathode of the blue lamp tube in each of the LED particles in each line are connected in parallel, and are connected with a drain of corresponding one of the N-MOS transistors in the second switching sub-circuit respectively;
an anode of the red lamp tube of each of the LED particles in each column is connected in parallel respectively, and is connected with a second end of corresponding one of the constant current logic components in the first constant current channel group respectively;
an anode of the green lamp tube of each of the LED particles in each column is connected in parallel respectively, and is connected with a second end of corresponding one of the constant current logic components in the second constant current channel group respectively; and
an anode of the blue lamp tube of each of the LED particles in each column is connected in parallel respectively, and is connected with a second end of corresponding one of the constant current logic components in the third constant current channel group respectively.

28. The display according to claim 1, wherein there are a red lamp tube, a green lamp tube and a blue lamp tube comprised in a LED particle in the LED display panel; wherein
the red lamp tube, the green lamp tube and the blue lamp tube are integrated in the LED particle; or
the red lamp tube, the green lamp tube and the blue lamp tube are arranged in the LED particle after being independently encapsulated respectively.

29. A Light-Emitting Diode (LED) control system, comprising: a display driving circuit, the display driving circuit comprising: a switching circuit, a driving circuit and a control circuit, wherein
a first end of one of the switching circuit and the driving circuit is connected to a power end of a power supply equipment, and a first end of the other of the switching circuit and the driving circuit is connected to a grounding end of the power supply equipment;
a second end of one of the switching circuit and the driving circuit is connected with an anode of the LED display panel, and a second end of the other of the switching circuit and the driving circuit is connected with a cathode of the LED display panel;
the control circuit comprises: a power supply control circuit and a driving control circuit; wherein
the power supply control circuit is connected with a third end of the switching circuit through a power supply control port, and is configured to control the switching-on or switching-off of the switching circuit;
the driving control circuit is connected with a third end of the driving circuit through a driving control port, and is configured to control the turning-on or cutting-off of the driving circuit; and
wherein the switching circuit is configured to control the power supply of the LED display panel, and the driving circuit is configured to control the ordered display of the LED display panel.
